(19) United States
(12) Patent Application Publication
(10) Pub. No.: US 2026/0126459 A1
(43) Pub. Date: May 7, 2026

(54) MODULE FOR DETECTING OR MEASURING ANALYTES IN FLUID

(71) Applicant: General Fluidics Corporation, Watertown, MA (US)

(72) Inventors: Robert Granier, Boston, MA (US); Anthony Lawrence Maida, Brighton, MA (US); Jesse Newton Jones, IV, Woburn, MA (US); Daniel Morris Hartmann, Arlington, MA (US)

(21) Appl. No.: 19/383,268

(22) Filed: Nov. 7, 2025

Related U.S. Application Data
(60) Provisional application No. 63/717,779, filed on Nov. 7, 2024.

(51) Int. Cl. G01N 35/00

(52) U.S. Cl. CPC G01N 35/00584; G01N 2035/00346; G01N 2035/00465

(57) ABSTRACT

Aspects of the present disclosure describe an analytical module for performing automated assays on fluids. The present disclosure provides an analytical module comprising a cylindrical housing attached to a rigid base supporting a motor. The housing includes magnets and a sensor. The module comprises a shuttle attached to the rotating motor shaft, nested within and free to rotate in the housing, configured to hold reaction vessels, and comprising a flag that interacts with the sensor to define position. The module includes a detector connected to the housing and a shroud shielding the detector from ambient light. The disclosure provides an immunoassay module with a system to perform magnetic bead-based immunoassays configured to shake reaction vessels for mixing and bead resuspension. Methods for performing immunoassays using the analytical module are provided.

### CROSS-REFERENCE TO RELATED APPLICATION(S)

This patent application claims the benefit of priority to U.S. Provisional Application No. 63/717,779, filed on Nov. 7, 2024, the entirety of which is incorporated herein by reference.

### TECHNICAL FIELD

Various embodiments of the present disclosure relate generally to systems and methods for measuring analytes in fluid, and, more particularly, to systems and methods for an analyzer for measuring analytes in fluid.

### BACKGROUND

Bead-based chemiluminescent immunoassays are among the most sensitive means of detecting proteins in analytical samples, and constitute the gold-standard of clinical diagnostic immunoassays. However, some commercialized immunoassay analyzers target medium-and high-throughput workflows, such as those found in hospitals and central laboratories. Such machines are large and expensive to own and operate. Their footprints, and cost-of-ownership make them inappropriate for low-throughput point-of-care environments, such as doctor offices and local clinics.

Some smaller point-of-care immunoanlyzers use less sensitive techniques, such as absorbance and chromatography-based assays. These instruments are not only insensitive, but often imprecise, leading to unacceptable diagnostic errors.

Small, point-of-care, bead-based chemiluminescent immunoassay instruments do exist. However, these instruments use single-use cartridges that contain the necessary reagents and disposables necessary to run a single assay. For instance, one such analyzer uses a disposable cartridge that comprises a pipette tip, a film-piercing trocar, a sheath to protect a magnet from contamination, an opaque read-well, and a series of 11 liquid wells containing the reagents needed for the run. The complexity of the consumable increases the per-sample cost of ownership. This is unacceptable in a point-of-care market where doctors are routinely constrained by factors such as insurance reimbursement rates. There is therefore an urgent need for a point-of-care immunoanlyzer that minimizes the consumable complexity and cost, while maintaining the bead-based chemiluminescent assay format that has become the gold-standard of sensitivity and accuracy in clinical diagnostics.

The present disclosure is directed to overcoming one or more of these above referenced challenges.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an analytical module is provided. The analytical module comprises a rigid base, a motor rigidly attached to the rigid base, and a cylindrical housing rigidly attached to the rigid base and having a hole in a bottom through which a shaft of the motor protrudes. The housing includes one or more magnets and a sensor. The analytical module further comprises a shuttle attached to a rotating shaft of the motor, the shuttle being nested within the housing and free to rotate within the housing. The shuttle is configured to hold one or more reaction vessels, and comprises a flag configured to interact with the sensor on the housing to define a unique position. The analytical module also comprises a detector connected to the housing and a shroud positioned so as to shield the detector from ambient light.

According to other aspects of the present disclosure, the analytical module may include one or more of the following features. The motor may be driven back-and-forth to cause the shuttle containing the one or more reaction vessels to rotate back-and-forth and thereby cause a liquid within the reaction vessels to mix, and to cause particles within the reaction vessels to be resuspended. The motor may be driven back-and-forth at a frequency of between 1 and 20 cycles per second. The motor that causes the shuttle to oscillate back and forth for mixing may also be used to position the shuttle at precise locations in the housing. The analytical module may further include a double pipettor probe configured to interact with the one or more reaction vessels, the double pipettor probe including a first probe and a second probe. The analytical module may further include a wash manifold configured to translate up and down between two positions, the wash manifold having pairs of aspirate and dispense probes, each pair of probes being configured so that when the wash manifold is in one of its position, the probes are engaged with corresponding reaction vessels. The shuttle may be rotated between multiple unique positions in the housing, the positions including a reaction vessel load and reaction vessel unload position where one or more reaction vessels may be loaded and unloaded, a magnet-engagement position where the one or more reaction vessels abut magnets in the housing, a wash position in which the one or more reaction vessels are positioned under the wash manifold and may engage with the wash manifold when it is one of its positions, a shake position in which the one or more reaction vessels are positioned far enough away from the magnets that a force from the magnets has no appreciable effect on contents of the one or more reaction vessels and the one or more reaction vessels may be aggressively shaken back-and-forth to mix their contents and/or resuspend one or more particles within them, and a read position in which the one or more reaction vessels may be sequentially positioned next to the detector so that light from within or shining through the one or more reaction vessels may be collected by the detector. The rotating shuttle may also be a heatblock and may have an attached heating element. Each reaction vessel may have a drain, and the rotating shuttle may further include a valve configured to gate the drain of each reaction vessel. The module may further include a manifold including one or more fluidic paths fluidically connected to the one or more reaction vessels through the valves. Each reaction vessel may be used to perform a unique immunoassay. One or more consumables used by the module to perform immunoassays may include one reaction vessel and two or three reagent vessels. Quantity “N” immunoassays may be performed in parallel using quantity “N” reaction vessels and quantity “2N+1” reagent vessels. The module may leverage cleaning solution provided by a system-level cleaning tank, and wash solution provided by a system-level wash tank.

According to another aspect of the present disclosure, an immunoassay module is provided. The immunoassay module includes a system to perform magnetic bead based immunoassays wherein the system is configured to shake one or more reaction vessels back and forth to accomplish mixing and bead resuspension.

According to other aspects of the present disclosure, the immunoassay module may include one or more of the following features. The module may include a rigid base, a motor connected to the rigid base, a linear translation stage configured to translate along the base, a shuttle connected to the linear translation stage so that the shuttle moves linearly with the linear translation stage, one or more reaction vessels connected to the translating shuttle, a detector connected to the base with the detector being at least partially covered by an opaque shroud, a magnet-manifold connected to the base with the magnet manifold including one or more magnets, and a sensor connected to the shuttle that works in concert with another piece of hardware mounted to the base such as a magnet, flag, or piece of metal to define a particular position along the base. The system may further include a wash manifold configured to translate up and down between two positions, the wash manifold having pairs of aspirate and dispense probes, each pair of probes being configured so that when the wash manifold is in one of its position, the probes are engaged with corresponding reaction vessels.

The module may include a fluidic sub-assembly having reaction vessels with output drains and valves that gate the outputs of the reaction vessels, and a shaker sub-assembly to which the fluidic sub-assembly may be mounted, the shaker sub-assembly having a shake motor separate and distinct from that of a positioning motor, the shake motor being configured to shake the fluidic sub-assembly back and forth at a frequency between 1 and 50 cycles per second. The fluidic sub-assembly may include a heatblock including one or more holes or slots for reaction vessels, one or more reaction vessels having output drains inserted into the slots or holes in the heatblock, a manifold connected to the heatblock with the manifold including one or more O-rings and a waste channel where the O-rings are configured to form liquid-tight seals with the outputs of the reaction vessels and to thereby create passages between the output of the reaction vessels and the manifold, one or more valves connected to the manifold with the valves gating the outputs of the reaction vessels such that when the valves are closed the reaction vessels cannot drain but when the valves are open the outputs of the reaction vessels are connected through the valves to the waste channel, and a pump attached to the waste channel and configured so that when a valve is open the pump can pull contents of an associated reaction vessel out of the vessel to waste. The shaker sub-assembly may include a shaker sub-assembly base, a linear stage shake carriage to connect to an immunoassay fluidic sub-assembly with the linear stage shake carriage connected to the shaker sub-assembly base, a linear stage shake rail connected to the linear stage shake carriage, a scotch yoke connected to the shaker sub-assembly base with the scotch yoke including a scotch yoke pin and scotch yoke follower, and a shake motor connected to the scotch yoke. The system may further include a linear positioning module connected to the shaker sub-assembly. The linear positioning module may include a frame, one or more magnets connected to the frame, a wash manifold connected to the frame, a detector connected to the frame, and a linear positioning stage connected to the frame. The immunoassay module may be embedded within a system that further includes a pipettor mounted to a gantry robot, a reservoir of system fluid, a pump configured to prime system fluid from the reservoir to the pipettor and aspirate and dispense fluids into the pipettor, a reservoir of cleaning fluid, a waste and wash station for washing the pipettor, a waste pump for pulling fluid out of the waste and wash station, and a light cover.

According to another aspect of the present disclosure, a method is provided. The method includes performing one or more immunoassays with a combination of near-simultaneous actions performed by an instrument assembly based on one or more immunoassay protocols using the analytical module.

According to other aspects of the present disclosure, the method may include one or more of the following features. The combination of actions may include moving a shuttle to a first position where one or more reaction vessels or a monolithic strip of reaction vessels can be loaded into the shuttle with the reaction vessels containing magnetic beads conjugated to capture antibodies configured to capture an analyte of interest from a sample, dispensing a plasma, blood, or urine sample and detector antibodies labeled with an enzyme into one or more of the reaction vessels, moving the shuttle to a second position at which mixing of the sample with the beads can occur through vigorous shaking of the shuttle, moving the shuttle to a third position at which magnets cause pelleting of the beads in the reaction vessels, engaging a wash manifold to dispense wash fluid into each of the reaction vessels, moving the shuttle slowly back-and-forth by a short distance so as to cause the pelleted beads to roll slightly to improve washing efficiency, aspirating wash fluid out of the reaction vessels through the wash manifold, repeating the dispense and aspirate steps until the beads are substantially-free of any non-specific binding, moving the shuttle to a fourth position where it can engage with a system-pipettor and using the system-pipettor to add chemiluminescent substrate to the reaction vessels with the chemiluminescent substrate configured to react with the enzyme linked to the detector antibody, moving the shuttle to a fifth position where it can engage with a detector such that luminescence or fluorescence from within the reaction vessels can be read sequentially by the detector, and using one or more voltages from the detector and a calibration curve stored in a processor to determine a quantity of analyte in the sample. The method may further include additional steps to remove waste and clean a probe after conducting an assay, the additional steps including moving the shuttle to the second position where an external pipettor can add a cleaning solution to the reaction vessels, moving the shuttle to the third magnet manifold position so that the magnetic beads in the reaction vessels are pelleted, and engaging the wash manifold with the reaction vessels and sequentially dispensing and aspirating wash fluid out of the reaction vessels until the probe is clean and the wash vessels are substantially empty.

In one embodiment, immunoassay module may include a support base. The immunoassay module may further include a movable shuttle that may move (through translation or rotation) to specific locations along the support base. The moveable shuttle may contain slots configured to removably hold a plurality of reaction vessels (RVs). The support base may support a housing. The support base and/or the housing may support a light-detector in one location, a magnet-manifold in a second location, and a wash manifold in a third location. A motor may be connected to the shuttle so that the shuttle may be moved from one location along the base to another, and so alternately engage with the magnetic manifold, the wash manifold, or the light detector.

The immunoassay module may contain a magnet-manifold assembly containing magnets configured so that they engage with the reaction vessels in the shuttle when the shuttle is moved to the magnet-manifold position. The magnets in the magnet-manifold may be rare earth magnets and may be of any desired shape and size. The magnets in the magnet-assembly may be assembled from multiple discrete magnets so as to achieve a desired shape, size, and magnetic field-strength. Alternatively, the magnets may be electromagnets.

The immunoassay module may contain a light detector. The light detector may be a photomultiplier tube (PMT), an avalanche photodiode (APD), a silicon photodiode, a silicon photomultiplier, or any other light-detector such as are known in the art. The light detector may have a shroud that protects it from stray light, and an opening in the shroud configured so that when the shuttle is moved to the light-detector, the detector is aligned with one of the reaction vessels in the shuttle.

The immunoassay module may contain a wash manifold. The wash manifold may be mounted above the magnet-manifold and may have two positions: an up position and a down position. The wash manifold may contain multiple channels and each channel may consist of an aspirate probe and a wash probe. The wash manifold may be configured so that when the shuttle is moved to the wash position, the aspirate and dispense probes on the wash manifold may be reversibly engaged with the reaction vessels.

The motor that drives the shuttle may be configured to accurately position the shuttle at specific positions within the module, so as to engage with the magnet manifold, wash-manifold, light-detector, or any other hardware that is attached to the immunoassay module. It may also be configured to aggressively shake the shuttle containing the reaction vessels back and forth to accomplish mixing.

The immunoassay module may have a linear form-factor. A linear translation stage may be connected to a linear rail mounted to the base, and the shuttle may be connected to the linear translation stage. The translating shuttle may driven by a belt or a lead-screw or any other mechanism as are commonly known in the art. A position sensor may be located on at least one spot on the base of the immunoassay module so as to define a unique reference point for moving shuttle. The magnet manifold, wash manifold, and light detector may be mounted on the base in different locations. During operation the shuttle may be driven by the motor to move linearly along the rail to a load position in which reaction vessels may be loaded into the shuttle; to a read position in which the reaction vessels may be sequentially positioned in front of the light-detector; to a shake position in which the reaction vessels may be aggressively shaken back and forth by the motor; to a reagent-loading position in which reagents may be added to the reaction vessels by a system pipettor; to a magnet-engagement position in which the reaction vessels are positioned in front of the magnet manifold; and to a wash position in which the reaction vessels are positioned under the wash manifold. In some embodiments the shake position, read position, and reagent-loading position may be substantially the same. In some embodiments the wash position is substantially the same as the magnet-manifold position.

Alternatively, the immunoassay module may have a cylindrical form-factor. The shuttle may be connected to the shaft of a motor, and its rotation may be driven directly by the motor. A position sensor may be located in at least one spot on a housing that surrounds the shuttle, so as to define a unique reference point for rotating shuttle. The magnets, wash manifold, and light detector may be mounted to the cylindrical housing in different locations. During operation the shuttle may be rotated by the motor to move to a load position in which reaction vessels may be loaded into the shuttle; to a read position in which the reaction vessels may be sequentially positioned in front of the light-detector; to a shake position in which the reaction vessels may be aggressively shaken back and forth by the motor; to a reagent-loading position in which reagents may be added to the reaction vessels by a system pipettor; to a magnet-engagement position in which the reaction vessels are positioned in front of the magnet manifold; and to a wash position in which the reaction vessels are positioned under the wash manifold. In some embodiments the shake position, read position, and reagent-loading position may be substantially the same. In some embodiments the wash position is substantially the same as the magnet-manifold position.

In some embodiments the shuttle is made from a thermally-conductive material and may comprise a heating and/or cooling element mounted to its side, the heater and shuttle configured to convey heat to or from the reaction vessels within the shuttle to achieve a desired temperature.

In some embodiments the immunoassay module has a light shield or enclosure that surrounds the module. The enclosure may have an access port to permit an external system pipettor to access the reaction vessels when they are moved to a particular reagent-loading position. An automated cover may be configured so that the access port can be reversibly opened and closed to alternately permit pipettor access or block external light from entering the module. In other embodiments, the immunoassay module may be embedded within a larger instrument so that it can make use of system-level hardware such as pumps and pipettors. In such cases, the module may be protected from light by the instrument cover and may therefore not require its own separate cover.

### BRIEF DESCRIPTION OF THE DRAWINGS

These and other features, aspects, and advantages of the present invention will become better understood with regard to the following description and accompanying drawings, where:

FIGS. 1A-1B show views of an analytical module, according to one or more embodiments.

FIG. 1A depicts an exploded view of an analytical module, according to one or more embodiments.

FIG. 1B depicts a collapsed view of an analytical module, according to one or more embodiments.

FIGS. 2A-2E show functional positions of the analytical module, according to one or more embodiments.

FIG. 2A shows reaction vessels (“RVs”) engaged with magnets in a housing, according to one or more embodiments.

FIG. 2B shows reaction vessels disengaged from magnets with tops free from obstruction, so that RVs may be loaded into their corresponding slots in a movable shuttle according to one or more embodiments.

FIG. 2C shows reaction vessels disengaged from magnets with tops free from obstruction, so that RVs may be accessed by a pipettor according to one or more embodiments.

FIG. 2D shows reaction vessels aligned with a detector, according to one or more embodiments.

FIG. 2E shows the shuttle in a position in which reaction vessels may be shaken through rapid back-and-forth movement of the motor which may be far away from the magnets, according to one or more embodiments

FIG. 3A-3B shows an analytical module having a detector in one of two positions, according to one or more embodiments.

FIG. 3A shows an analytical module having the detector mounted in a top-down position so that the detector interrogates the reaction vessels from the top, according to one or more embodiments.

FIG. 3B shows an analytical module having the detector mounted in a side-position so that the detector interrogates the reaction vessels from the side, according to one or more embodiments.

FIGS. 4A-4C show the analytical module during a mixing and resuspension operation, according to one or more embodiments.

FIG. 4A shows the analytical module prior to mixing, according to one or more embodiments.

FIG. 4B shows the analytical module partway through mixing, according to one or more embodiments.

FIG. 4C shows the analytical module nearly complete with mixing, according to one or more embodiments.

FIGS. 5A-5B shows views of the analytical module having an excitation source and filter wheel, according to one or more embodiments.

FIG. 5A shows analytical module with a filter wheel, according to one or more embodiments.

FIG. 5B shows analytical module with an excitation source, according to one or more embodiments.

FIG. 6A-6B shows a double pipettor that may be part of a wash manifold in the analytical module, according to one or more embodiments.

FIG. 6A shows a double pipettor and a reaction vessel, according to one or more embodiments.

FIG. 6B shows a double pipettor in a reaction vessel, according to one or more embodiments.

FIG. 7A-B shows the analytical module (e.g. immunoassay module) with attached multichannel wash manifold according to one or more embodiments.

FIG. 7A shows the analytical module (e.g. immunoassay module) with attached multichannel wash manifold in the up position, disengaged from the RVs, according to one or more embodiments.

FIG. 7B shows the analytical module (e.g. immunoassay module) with attached multichannel wash manifold in the down position, engaged with the RVs, according to one or more embodiments.

FIGS. 8A-8S shows an analytical module with a translating shuttle with linear translation stage, according to one or more embodiments.

FIG. 8A shows a side view of the analytical module, according to one or more embodiments.

FIGS. 8B-8C depict a shuttle that holds reaction vessels, according to one or more embodiments

FIG. 8B depicts the front of a reaction-vessel-shuttle with the reaction vessels (RVs) withdrawn from their corresponding slots in the shuttle, according to one or more embodiments.

FIG. 8C depicts a back-side of a reaction vessel shuttle with the reaction vessels inserted into their corresponding slots in the shuttle, according to one or more embodiments.

FIG. 8D shows an isometric view of a wash manifold assembly, according to one or more embodiments.

FIGS. 8E-8F show front views of two states of a wash manifold assembly, according to one or more embodiments.

FIG. 8E shows the wash manifold assembly in an up position, disengaged from the RVs in the shuttle below it, according to one or more embodiments.

FIG. 8F shows the wash manifold assembly in a down position, engaged from the RVs in the shuttle below it, according to one or more embodiments.

FIGS. 8G-8J show details of the process by which the wash manifold dispenses and aspirates wash fluid into and out of an RV in the shuttle, according to one or more embodiments.

FIG. 8G shows a close-up view of one channel in the wash manifold when the wash manifold is engaged with the shuttle, and the reaction vessel of this channel is empty, according to one or more embodiments.

FIG. 8H shows a close-up view of one channel in the wash manifold when the wash manifold is engaged with the shuttle, and the dispense probe of the wash manifold channel is dispensing fluid into the reaction vessel below it, according to one or more embodiments.

FIG. 8I shows a close-up view of one channel in the wash manifold when the wash manifold is engaged with the shuttle, and the dispense probe has filled the reaction vessel below it with a volume of fluid, according to one or more embodiments.

FIG. 8J shows a close-up view of one channel in the wash manifold when the wash manifold is engaged with the shuttle, and the aspirate probe has pulled almost all the liquid out of the reaction vessel below it, according to one or more embodiments.

FIGS. 8K-8L shows views of a magnet manifold assembly, according to one or more embodiments.

FIG. 8K shows a partially-exploded view of the magnet manifold, assembly according to one or more embodiments.

FIG. 8L shows a collapsed view of the magnet manifold, assembly according to FIG. 8K.

FIGS. 8M-8P shows the immunoassay module with the shuttle located in different functional positions, according to one or more embodiments.

FIG. 8M shows the immunoassay module with the shuttle located in the load-RV position, according to one or more embodiments.

FIG. 8N shows the immunoassay module with the shuttle located in a position where the shuttle may shake, where a system pipettor may dispense liquids into and out of an RV, and where the shuttle may be moved in front of a light-detector, according to one or more embodiments.

FIG. 8O shows the immunoassay module with the shuttle located in a position in front of the magnet assembly with the wash manifold in the up position, where magnetic beads may be pelleted, according to one or more embodiments.

FIG. 8P shows the immunoassay module with the shuttle located in a position in front of the magnet assembly with the wash manifold in the down position, where magnetic beads may be pelleted and washed, according to one or more embodiments.

FIGS. 8Q-8S show the immunoassay module in an enclosure and certain features of the enclosure, according to one or more embodiments.

FIG. 8Q shows the enclosure around the immunoassay module, according to one or more embodiments.

FIG. 8R shows a transparent view of the enclosure, showing the immunoassay module inside it, according to one or more embodiments.

FIG. 8S is a detailed view of a portion of the immunoassay module enclosure, showing a sliding cover, driven by an actuator, configured to open and close a pipette access port, according to one or more embodiments.

FIGS. 9A-9B show an analytical module that uses reaction vessels with an input and output, according to one or more embodiments.

FIG. 9A depicts an exploded view of the analytical module, according to one or more embodiments.

FIG. 9B depicts a collapsed view of the analytical module, according to FIG. 9A.

FIG. 10 shows a cross sectional view of a portion of an analytical module that has reaction vessels with an input and an output-drain.

FIG. 11 shows a fluidic sub-assembly of an exemplary embodiment of the analytical module where the analytical module is a linear immunoassay module, according to one or more embodiments.

FIG. 12 shows a shaking sub-assembly responsible for shaking the reaction vessels of a linear immunoassay analytical module, according to one or more embodiments.

FIG. 13 shows an analytical module in which the functions of aggressive shaking and accurate-positioning have been separated, according to one or more embodiments.

FIG. 14 shows a box and whisker plot showing exemplary results of an immunoassay performed on the analytical module, according to one or more embodiments.

FIG. 15A shows an isometric view of a stir-pipettor, according to one or more embodiments.

FIG. 15B shows a bottom view of the stir-pipettor with a zoomed-in view of the pipette as it is moved in a circular arc, according to one or more embodiments.

FIG. 16 shows a waste/wash station of the fluidic system of the systems described herein, according to one or more embodiments.

FIG. 17 shows fluid architecture of an exemplary system of the present disclosure including integrated module, a wash station, and a pipette system for use in processing samples, according to one or more embodiments.

FIGS. 18A-18B depict cartridges, reaction vessels, and reagent vessels, according to one or more embodiments.

FIG. 18A shows a cartridge that resembles a well-plate, according to one or more embodiments.

FIG. 18B shows reaction vessels and reagent vessels, according to one or more embodiments.

FIG. 19 depicts a table of steps that may be used to perform a magnetic-bead-based immunoassay and the associated positions that may be used to conduct those steps, according to one or more embodiments.

FIG. 20 depicts a controller for the system, according to one or more embodiments.

### DETAILED DESCRIPTION

Various embodiments of the present disclosure relate generally to systems and methods for measuring analytes in fluid, and, more particularly, to systems and methods for an analyzer for measuring analytes in fluid.

One or more embodiments may provide that the analytical module of the present disclosure may include an immunoanalyzer that includes a system to perform a magnetic bead based immunoassay wherein the system is configured to shake one or more reaction vessels back and forth to accomplish mixing. One or more embodiments may provide an immunoassay analyzer including a base, a motor connected to the base, a movable shuttle connected to the motor, the shuttle configured to move one or more reaction vessels and a sensor or sensor-flag to different positions along the base, including a detector position, a magnet-engagement position, a wash position, a reagent-loading position, a reaction-vessel loading position, and a shake position. One or more embodiments may provide performing one or more immunoassays with a combination of simultaneous or near-simultaneous actions performed by an instrument assembly based on one or more immunoassay protocols.

One or more embodiments may include an analytical module with a rigid base, a motor rigidly attached to the rigid base, a cylindrical housing rigidly attached to the rigid base and having a hole in a bottom through which a shaft of the motor protrudes, the housing including one or more magnets and a sensor, a shuttle attached to a rotating shaft of the motor, the shuttle being nested within the housing and free to rotate within the housing, the shuttle configured to hold one or more reaction vessels, and comprising a flag configured to interact with the sensor on the housing to define a unique position, a detector connected to the housing, and a shroud positioned so as to shield the detector from ambient light. A shuttle may work in concert with another piece of hardware mounted to a base such as a magnet, flag, or piece of metal, and define a particular position along the base.

One or more embodiments may include an analytical module wherein the shuttle may be rotated between multiple unique positions in the housing, and where the positions include: (a) reaction vessel load and reaction vessel unload position where one or more reaction vessels may be loaded and unloaded; (b) a magnet-engagement position where the one or more reaction vessels abut magnets in the housing; (c) a wash position in which the one or more reaction vessels are positioned under the wash manifold and may engage with the wash manifold when it is one of its positions; (d) a shake position in which the one or more reaction vessels are positioned far enough away from the magnets that a force from the magnets has no appreciable effect on contents of the one or more reaction vessels, and the one or more reaction vessels may be aggressively shaken back-and forth to mix their contents and/or resuspend one or more particles within them; and (e) a read position in which the one or more reaction vessels may be sequentially positioned next to the detector so that light from within or shining through the one or more reaction vessels may be collected by the detector.

One or more embodiments may include performing one or more immunoassays with a combination of near-simultaneous actions performed by an instrument assembly based on one or more immunoassay protocols using an analytical module, wherein the combination of actions includes: moving a shuttle to a first position where one or more reaction vessels, or a monolithic strip of reaction vessels can be loaded into the shuttle, the reaction vessels containing magnetic beads conjugated to capture antibodies configured to capture an analyte of interest from a sample; dispensing a plasma, blood, or urine sample and detector antibodies labeled with an enzyme into one or more of the reaction vessels; moving the shuttle to a second position at which mixing of the sample with the beads can occur through vigorous shaking of the shuttle; moving the shuttle to a third position at which magnets cause pelleting of the beads in the reaction vessels; engaging a wash manifold to dispense wash fluid into each of the reaction vessels; moving the shuttle slowly back-and-forth by a short distance so as to cause the pelleted beads to roll slightly to improve washing efficiency; aspirating wash fluid out of the reaction vessels through the wash manifold; repeating the dispense and aspirate steps until the beads are substantially-free of any non-specific binding; moving the shuttle to a fourth position where it can engage with a system-pipettor, and using the system-pipettor to add chemiluminescent substrate to the reaction vessels, the chemiluminescent substrate configured to react with the enzyme linked to the detector antibody; moving the shuttle to a fifth position where it can engage with a detector such that luminescence or fluorescence from within the reaction vessels can be read sequentially by the detector; and using one or more voltages from the detector and a calibration curve stored in a processor, to determine a quantity of analyte in the sample.

One or more embodiments may include a quantity “N” immunoassays may be performed in parallel using quantity “N” reaction vessels and quantity “2N+1” reagent vessels, and no additional consumable hardware is required.

An aspect of the present disclosure includes an analytical module configured to perform automated assays on fluids. An aspect of the present disclosure includes a fluidic system and methods for carrying out the automated assays on the analytical module described herein.

In some embodiments, the module has disposable or reusable reaction vessels in which individual assays may be conducted. In some embodiments, the analytical module keeps those reaction vessels at a controlled temperature as it moves them from one location to another. In some embodiments, the module has a motor that enables it to shake a shuttle holding the reaction vessels, thereby causing mixing, and/or suspension of particulates within the vessels. In some embodiments the, module may also have added functional elements including, but not limited to: heaters, coolers, magnets, emitters, detectors, and electrodes. In some embodiments, the module can position the reaction vessels at locations to enable their interaction with these elements.

The analytical module of the present disclosure enables rapid, sensitive, flexible, coordinated, and/or integrated automation of immunoassays by combining/coordinating timings and spatial orientation of all the following actions/steps in a compact instrument space.

In some embodiments, the analytical module comprises a rotary shuttle or linear shuttle holding reaction vessels for simultaneously analyzing one patient sample for several immunoassays or several patient samples for one immunoassay.

In some embodiments, the analytical module comprises a rotary shuttle or linear shuttle holding reaction vessels for simultaneously analyzing a patient sample(s), controls and/or calibrants for self-contained analysis of unknowns against standards.

In some embodiments, the analytical module comprises a rotary shuttle or linear shuttle that moves a set of reaction vessels in a coordinated fashion between stations for independent, staggered or simultaneous performance of different immunoassay steps across individual reaction vessels.

In some embodiments, the analytical module comprises a rotary shuttle or linear shuttle that extends from the instrument via a drawer or other access port for loading/removal of reagents and reaction vessels by the operator.

In some embodiments, the analytical module comprises a rotary shuttle or linear shuttle that controls temperature, mixes reagents/samples, suspends magnetic beads and moves reaction vessels between mixing, incubation, wash, magnetic pelleting and detection stations.

In some embodiments, the analytical module comprises a rotary shuttle or linear shuttle that moves a reaction vessel back and forth a short distance as a bead pellet is magnetically held against the wall of the reaction vessel for efficient washing of the pellet by an aspirate/dispense manifold.

In some embodiments, the analytical module comprises a set of magnets positioned and spaced to enable rapid, tight and reversible pelleting of magnetic beads in an independent, staggered or simultaneous manner across blocks of reaction vessels (RVs).

In some embodiments, the analytical module comprises a set of magnets with orientations selected to generate magnet fields/poles (e.g., north/north/north, south/north/south) that promote rapid, tight and reversible pelleting of magnetic beads across reaction vessels in a compact space with controlled magnetic field patterns.

In some embodiments, the analytical module comprises a wash manifold for rapid, independent and consistent aspirate and dispense washing of suspended or pelleted magnetic beads across a set of reaction vessels in combination/coordination with an array of magnets and mixing by a shaking shuttle.

In some embodiments, the analytical module accepts a consumable comprising anywhere from 1 to 10 reagent wells.

In some embodiments, the analytical module comprises a detector(s) for independently measuring immunoassay signals across individual reaction vessels over time without crosstalk between reaction vessels.

In some embodiments, the analytical module comprises an array of magnets that may be used to pellet magnetic beads used in some assays.

In some embodiments, the analytical module mixes reagents and resuspends magnetic beads by aggressively shaking a shuttle containing reaction vessels back and forth.

Other aspects of this invention are related to features and processes that enable the integration of this analytical module with other analytical modules that share common subsystems such as consumables, user interfaces, liquid handling systems, electronics and software.

Another aspect of the present disclosure includes an analytical module with a linear shuttle capable of being integrated into a user interface (e.g. drawer) shared by other modules so that the user can add consumables for the immunoassay module along with consumables for other analytical modules (e.g. hematology module, clinical chemistry module).

In some embodiments, the analytical module comprises means to enable the module to use hardware and consumables designed to interact with the shared hardware resources of a multi-module system.

Another aspect of the present disclosure includes an analytical module with hardware and processes that allow the interweaving of processes performed by shared hardware and software resources between one or more additional modules.

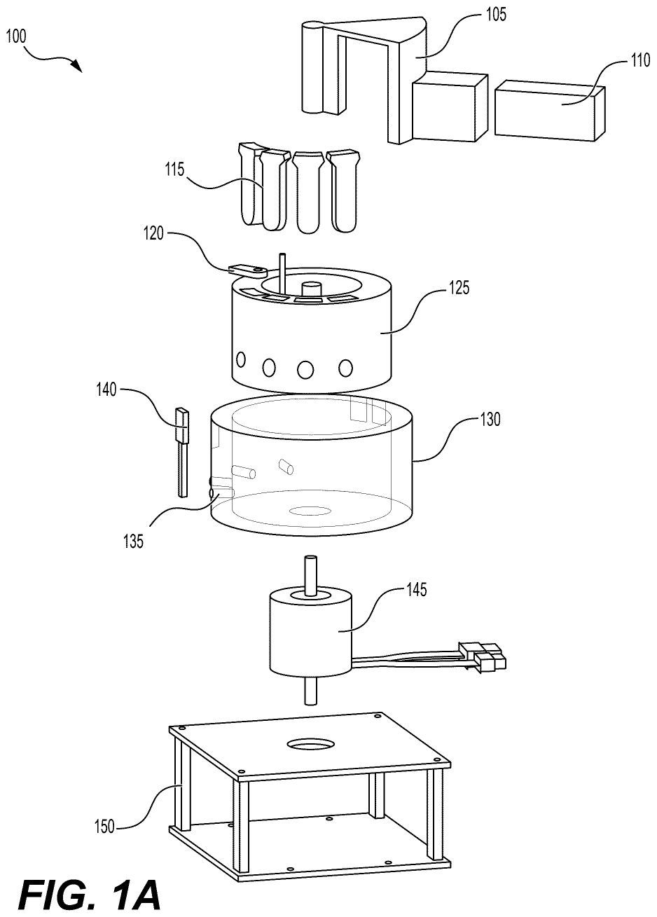

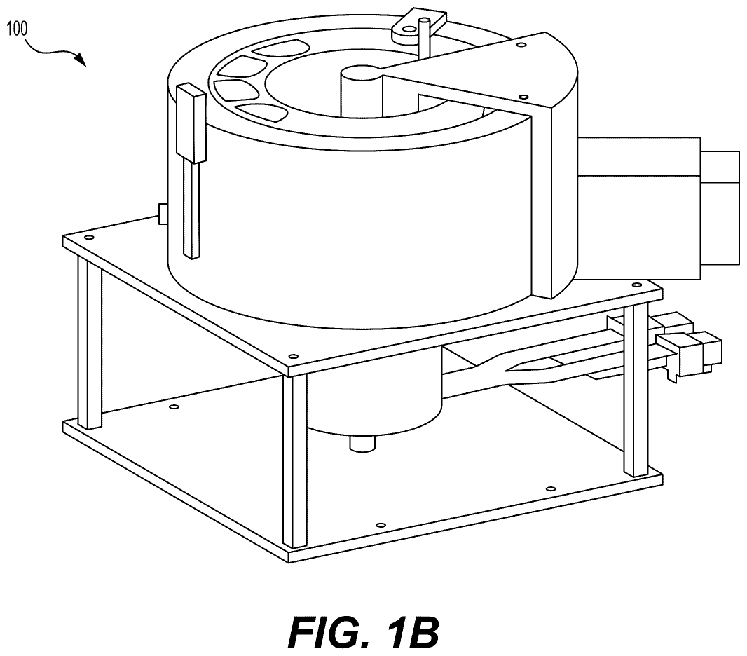

FIGS. 1A-1B show views of an analytical module, according to one or more embodiments.

FIG. 1A depicts an exploded view of an analytical module, according to one or more embodiments. Module 100 may include a shroud 105, detector 110, reaction vessels 115, flag 120, movable shuttle 125, housing 130, magnets 135, sensor 140, motor 145, and support base 150. In the assembly of module 100, reaction vessels 115 may be enclosed by the shroud 105. Module 100 may include a support base 150 and a housing 130, through which various parts of the module are connected. Module 100 may further include a movable shuttle 125, containing at least one reaction vessel, for example reaction vessels 115. The movable shuttle 125 may be attached to motor 145 through a coupling mechanism so that the shuttle may be rotated to any location along the housing. The module may further include a detector 110, such as a photomultiplier tube (PMT), an avalanche photodiode (APD) a silicon photodiode, a silicon photomultiplier, or any other light-detector such as are known in the art. The detector may be substantially enclosed by a shroud 105 that protects it from stray light, and an opening in the shroud configured so that when the shuttle is moved to the light-detector, the detector is aligned with one of the reaction vessels in the shuttle.

The immunoassay module 100 may further contain at least one magnet 135, and may contain a plurality of magnets. The magnet(s) may be engaged with the reaction vessels in the shuttle when the shuttle is moved to the magnet-manifold position. The magnets in the magnet-manifold may be rare earth magnets or electromagnets and may be of any desired shape and size. The magnets in the magnet-assembly may be assembled from multiple discrete magnets so as to achieve a desired shape, size, and magnetic field-strength.

The housing may support a sensor 140, and the rotating shuttle may support a flag, 120, which together enable the rotating shuttle to move to a known location. The sensor may be a magnetic Hall sensor, an inductive proximity sensor, a capacitive sensor, a mechanical switch, an optical sensor, or any other sensor such as are commonly used for positioning and are well-known in the art. Similarly, the flag may be a magnet, or a piece of metal, or a mechanical boss that may interact with the sensor to uniquely define a specific rotary position.

FIG. 1B depicts a collapsed view of an analytical module, according to one or more embodiments. Module 100 may include a shroud 105, detector 110, reaction vessels 115, flag 120, movable shuttle 125, housing 130, magnets 135, sensor 140, motor 145, and support base 150, as seen for example in FIG. 1A.

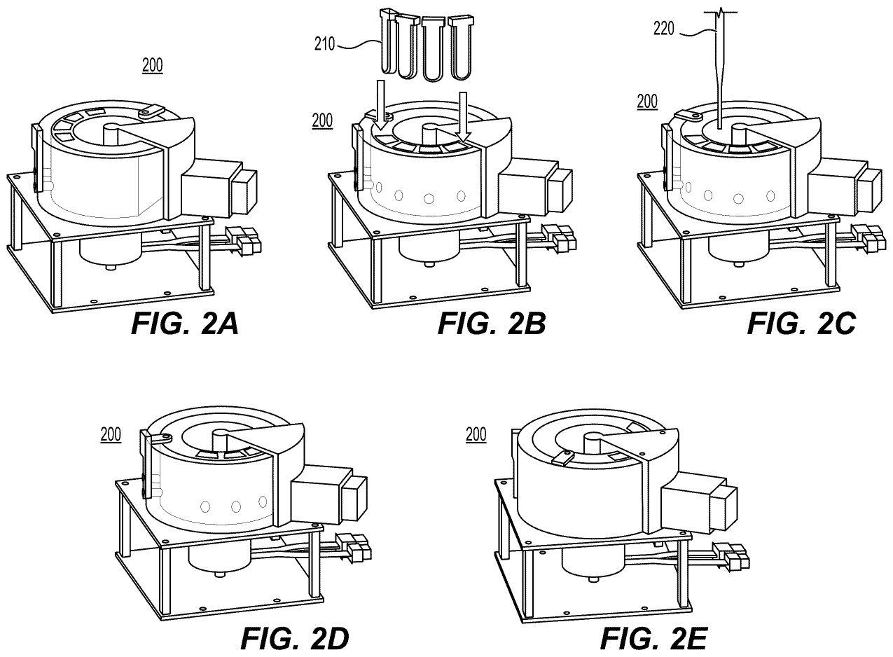

FIGS. 2A-2E show functional positions of the analytical module, according to one or more embodiments.

FIG. 2A shows reaction vessels (“RVs”) engaged with magnets in a housing, according to one or more embodiments. Analytical module 200 may have different functional positions. In the position of FIG. 2A the magnet(s) in the housing are engaged with reaction vessels (RVs). As illustrated, there is one magnet for each RV, so that when the shuttle is positioned as shown, each RV interacts with a magnet. However, the shuttle may also be incrementally rotated so that fewer RVs are engaged with magnets at any given time. Furthermore, it is not necessary that every hole in the housing be populated with a magnet. Thus, depending on the number of magnets held in the housing, and the precise location of the shuttle, one or more RVs may be engaged to interact with magnets in this location.

FIG. 2B shows reaction vessels disengaged from magnets with tops free from obstruction, according to one or more embodiments. In this position, analytical module 200 may include reaction vessels 210. In this position the RVs are disengaged from the magnets and their tops are free of obstruction. In this position, reaction vessels may be loaded into the shuttle or reagents for assays may be added to or removed from each reaction vessel for instance by a pipettor.

FIG. 2C shows reaction vessels disengaged from magnets with tops free from obstruction, so that RVs may be accessed by a pipettor according to one or more embodiments. In this position, analytical module 200 may include pipette 220.

FIG. 2D shows reaction vessels aligned with a detector, according to one or more embodiments. In this position one of the RVs is aligned with a detector so that the detector may receive a signal from the RV. For instance, the detector may be a photomultiplier tube that receives light from a chemiluminescent reaction occurring in the RV. With incremental rotation of the shuttle, each RV can be positioned in front of the detector in tum. A shroud helps protect the detector from ambient light. In this position, a pipettor has limited access to the top of the RVs.

FIG. 2E shows the shuttle in a position in which reaction vessels may be shaken through rapid back-and-forth movement of the motor which may be far away from the magnets, according to one or more embodiments. An aspect of the immunoassay module may include that the rapid back-and-forth motion of the motor may shake the RVs in such a way as to cause their contents to be mixed, and/or to cause pelleted beads within the RV to be resuspended in solution.

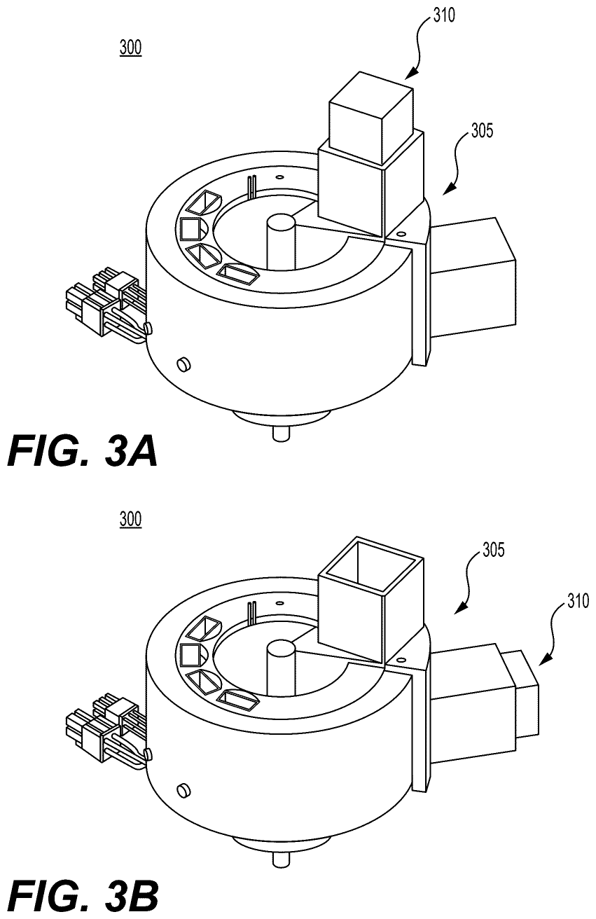

FIG. 3A-3B shows an analytical module having a shroud that holds a detector in either a side-mounted position or a top-down position, according to one or more embodiments.

FIG. 3A shows an analytical module having the detector mounted in a top-down position so that the detector interrogates the reaction vessels from the top, according to one or more embodiments. Module 300 may include shroud 305 and detector 310. FIG. 3B shows an analytical module having the detector mounted in a side-position so that the detector interrogates the reaction vessels from the side, according to one or more embodiments. Module 300 may include shroud 305 and detector 310.

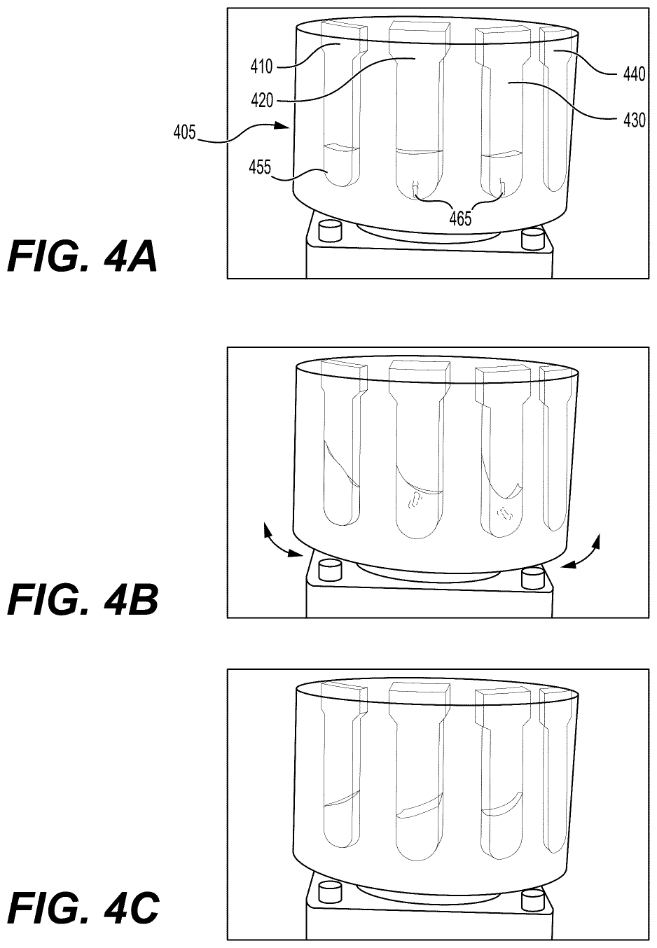

FIGS. 4A-4C show the analytical module during a mixing and resuspension operation, according to one or more embodiments. FIGS. 4A-4C may include depictions of one exemplary embodiment of the analytical module during rapid back-and-forth movement of motor that enables mixing and resuspension.

FIG. 4A shows the analytical module prior to mixing, according to one or more embodiments. FIG. 4A may depict the analytical module prior to mixing. Shuttle 405 may include first reaction vessel 410, second reaction vessel 420, third reaction vessel 430, and fourth reaction vessel 440. The plurality of reaction vessels may include reagents and/or particles, including magnetic beads. For example, first reaction vessel 410 may include reagent 455. Also, second reaction vessel 420 and third reaction vessel 430 may include magnetic bead pellets 465.

FIG. 4B shows the analytical module partway through mixing, according to one or more embodiments. FIG. 4B may depict the analytical module part-way through mixing. FIG. 4B may include quick back-and-forth rotation of the motor causing liquid to climb up a first side of the RVs. The magnetic bead pellets may be partially resuspended.

FIG. 4C shows the analytical module nearly completed with mixing, according to one or more embodiments. FIG. 4C may depict the analytical module nearly completed with mixing. FIG. 4C may include quick back-and-forth rotation of the motor causing liquid to climb up a second side of the RV, resulting in a rapid mixing, and full re-suspension of the magnetic particles.

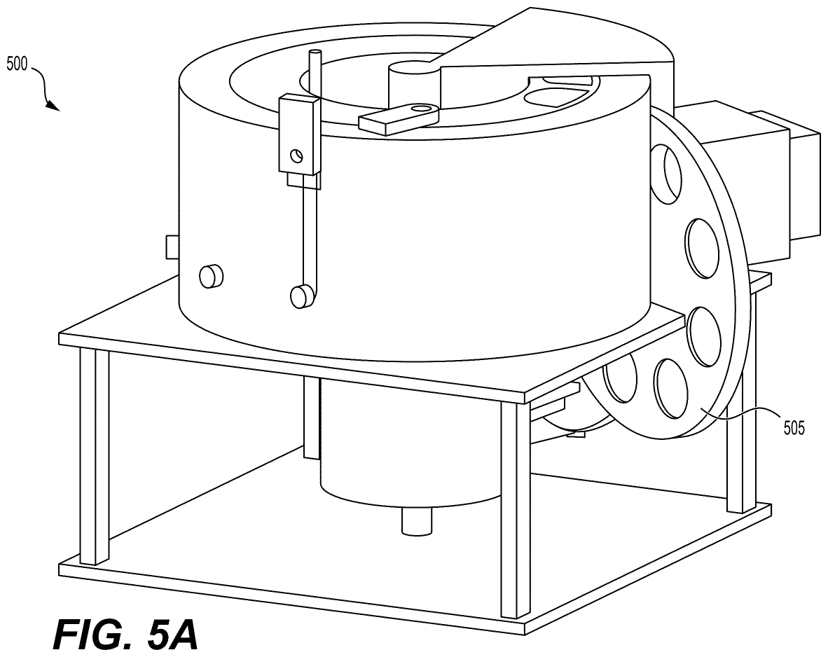

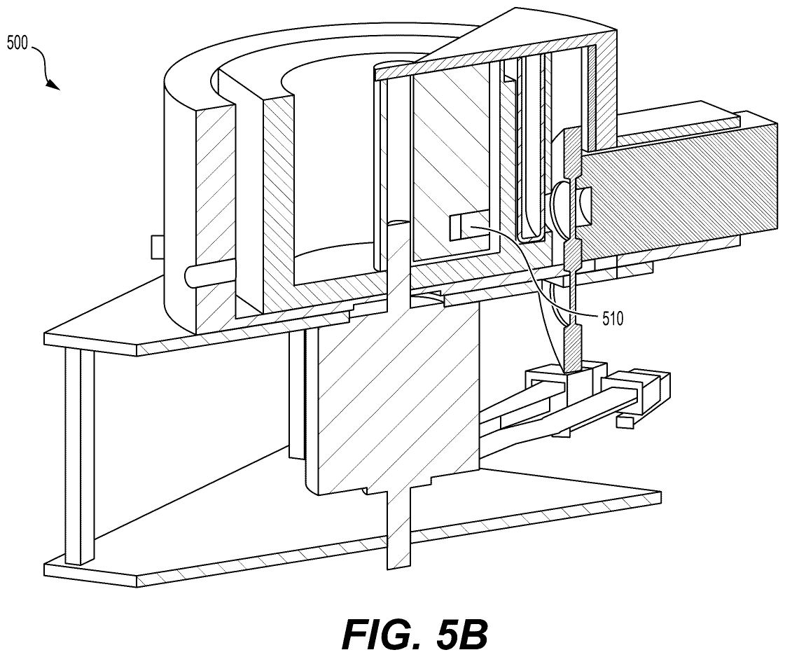

FIGS. 5A-5B shows views of the analytical module having an excitation source and filter wheel, according to one or more embodiments. FIGS. 5A-5B show an Isometric view (for example, FIG. 5A) and cross-sectional view (for example, FIG. 5B of one exemplary embodiment of the analytical module having an excitation source and filter wheel.

FIG. 5A shows analytical module with a filter wheel, according to one or more embodiments. Module 500 may include filter wheel 505.

FIG. 5B shows analytical module with an excitation source, according to one or more embodiments. Module 500 may include excitation source 510, which may be a light source.

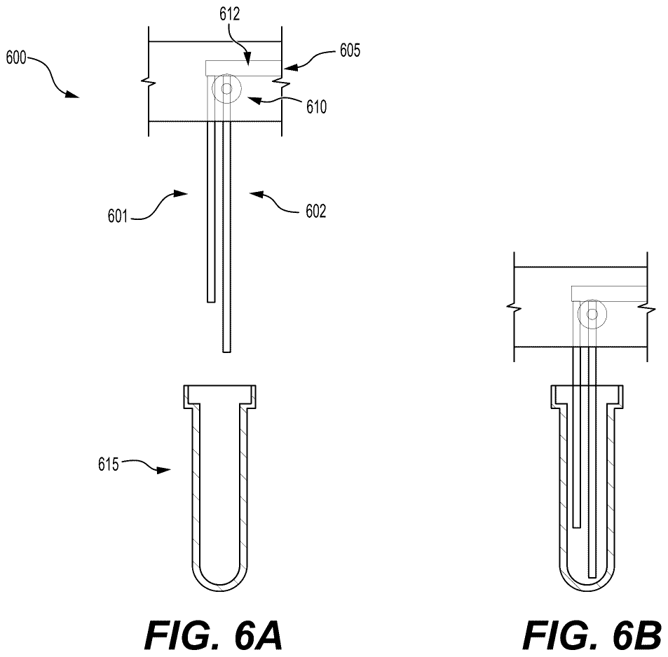

FIG. 6A-6B shows a double pipettor that may be part of a wash manifold in the analytical module, according to one or more embodiments. FIG. 6A-B shows a double pipettor probe that may be part of a wash manifold that is part of the analytical module or fluidic system.

FIG. 6A shows a double pipettor and a reaction vessel, according to one or more embodiments. FIG. 6A shows a double pipettor probe in an up position, disengaged from reaction vessel 615. Pipettor and reaction vessel assembly 600 may include a double pipettor probe and reaction vessel 615. Double pipettor probe may include dispense probe 601, aspirate probe 602, wash input 605, aspirate out 610, and wash channel 612.

FIG. 6B shows a double pipettor in a reaction vessel, according to one or more embodiments. FIG. 6B shows a double pipettor probe in a down position, engaged with reaction vessel 615.

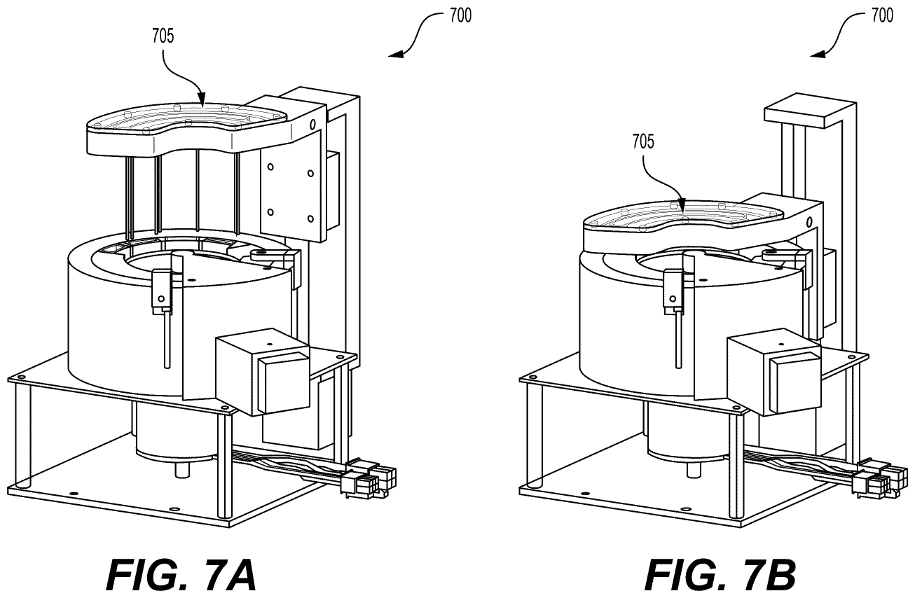

FIG. 7A-B shows the analytical module e.g. (immunoassay) module with a multichannel wash station or multichannel pipettor above it, according to one or more embodiments. Module 700 may include multichannel wash assembly 705.

FIG. 7A shows the analytical module e.g. (immunoassay) module with a multichannel wash station or multichannel pipettor disengaged from the RVs. Module 700 may include multichannel wash assembly 705 disengaged from one or more reaction vessels. Multichannel wash assembly 705 may be a multichannel wash station or multichannel pipettor.

FIG. 7B shows the analytical module e.g. (immunoassay) module with a multichannel wash station or multichannel pipettor engaged with the RVs. Module 700 may include multichannel wash assembly 705 engaged from one or more reaction vessels.

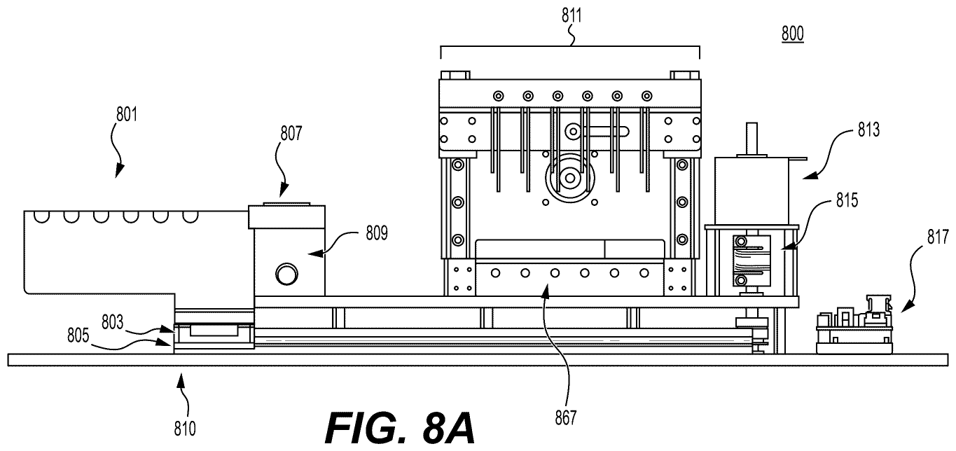

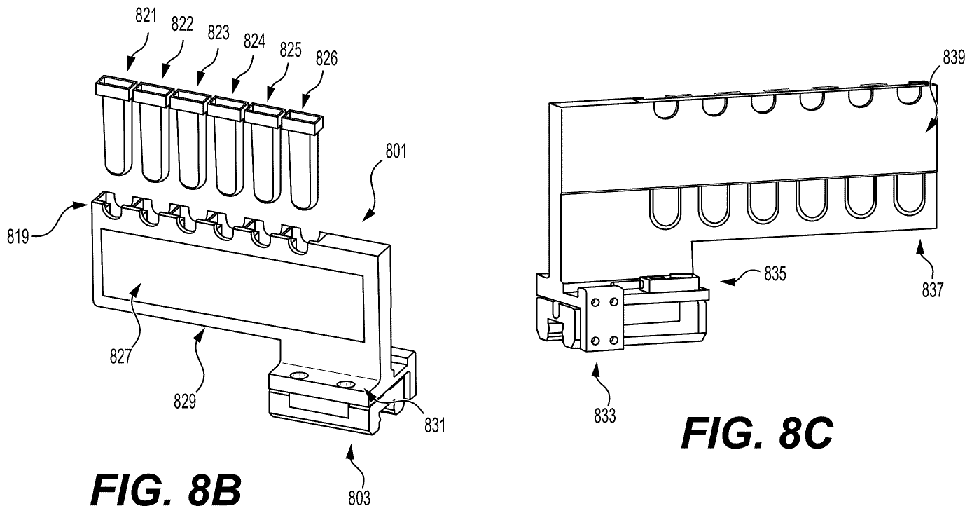

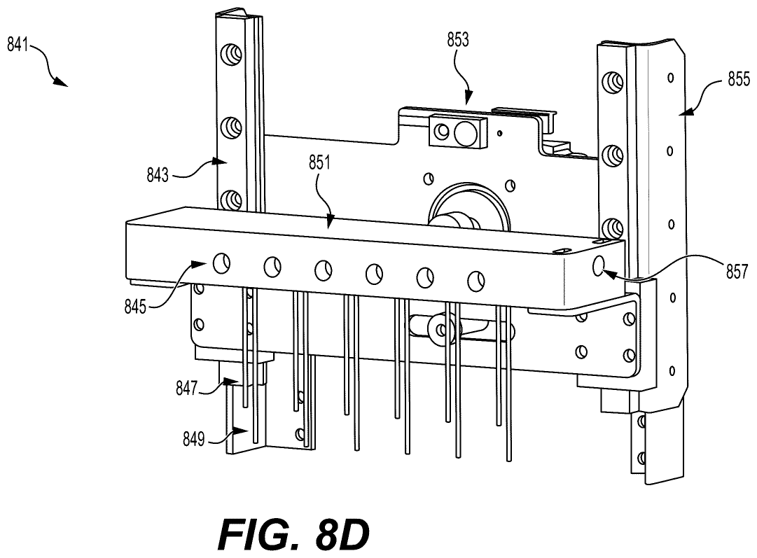

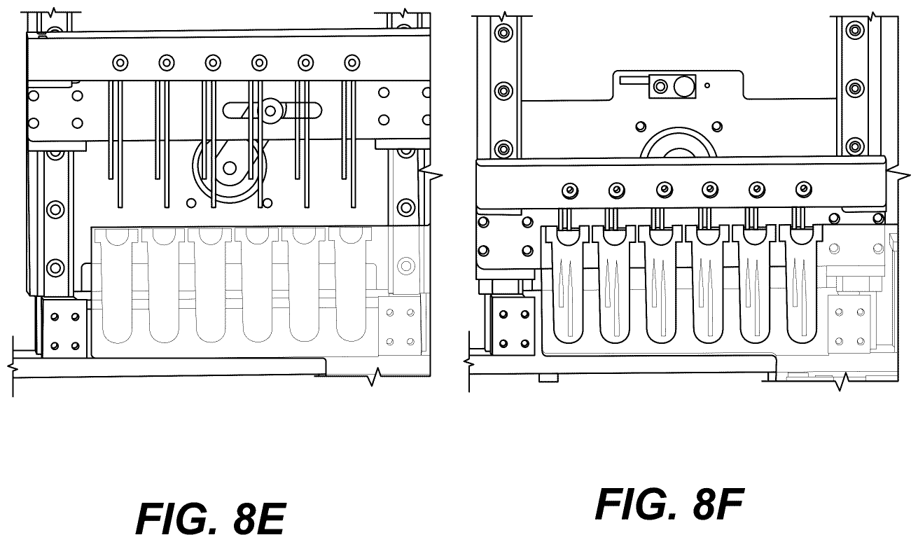

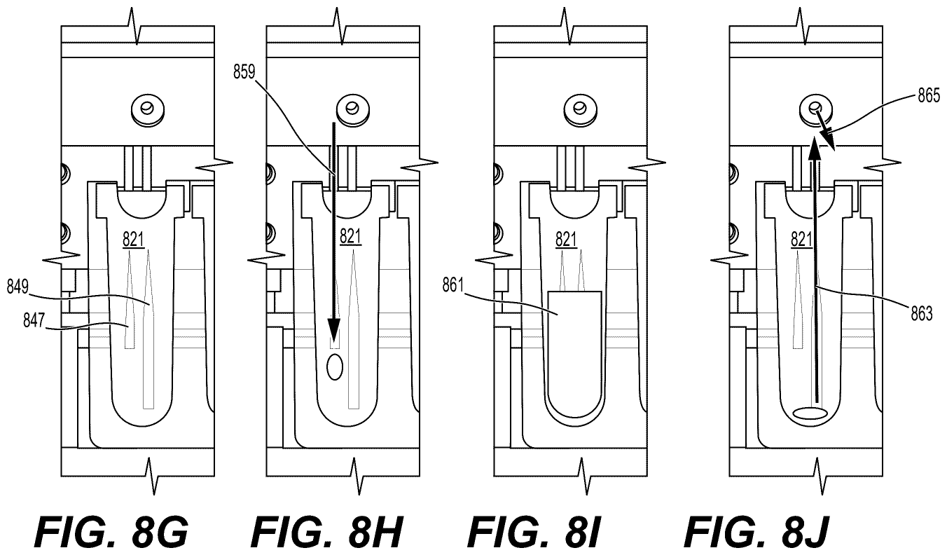

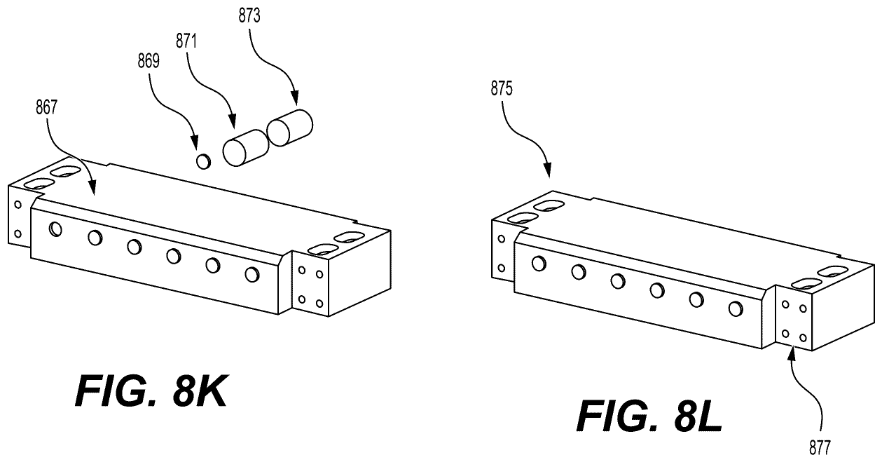

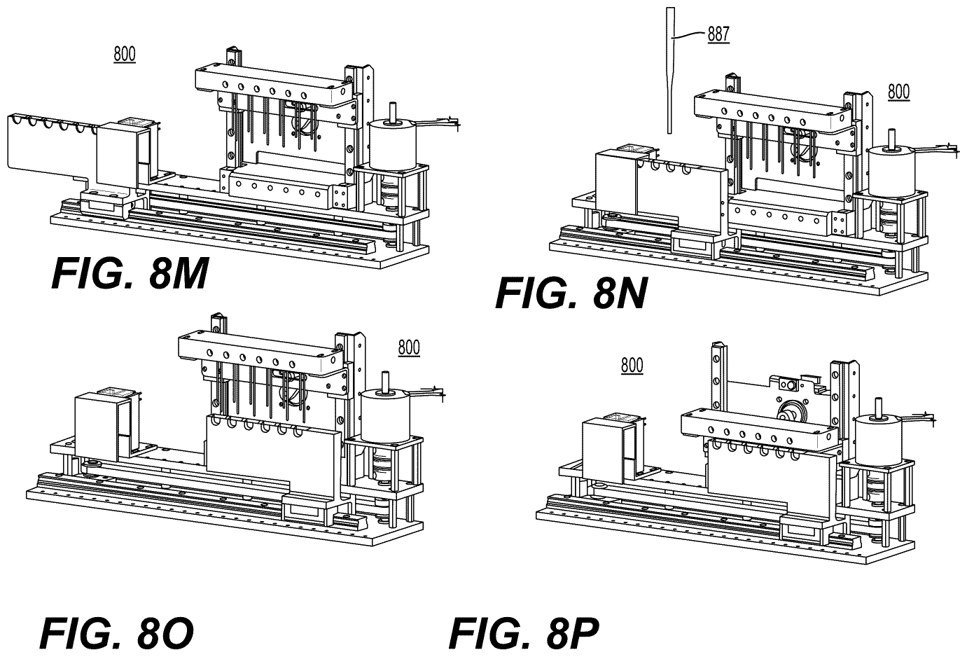

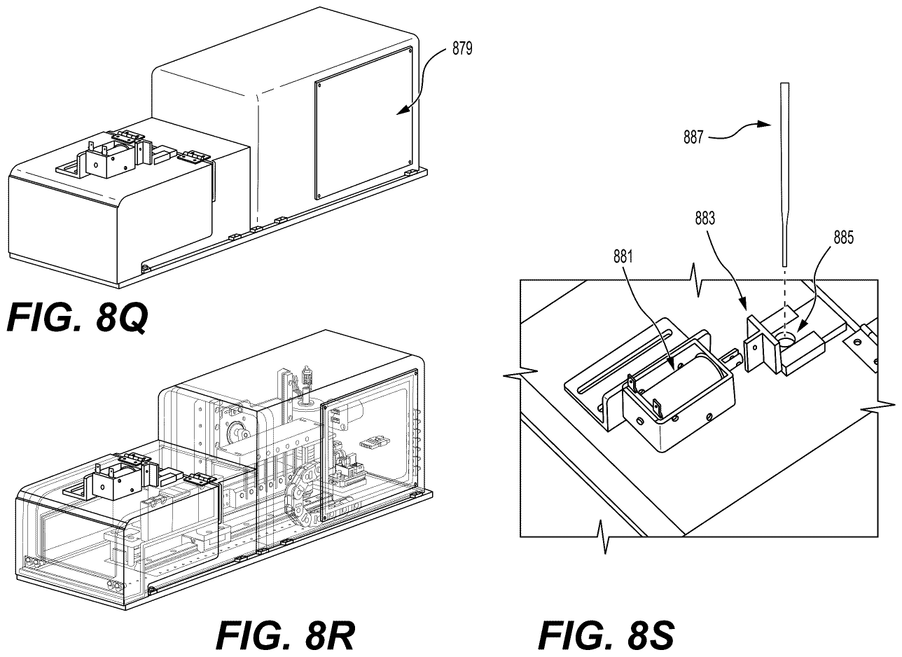

FIGS. 8A-8S shows an analytical module with a translating shuttle with linear translation stage, according to one or more embodiments.

FIG. 8A shows a side view of the analytical module, according to one or more embodiments. Module 800 may include reaction vessel shuttle 801, linear stage 803, linear rail 805, light detector 807, shroud 809, support base 810, wash manifold assembly 811, motor 813, motor coupler 815, motor controller 817, and magnet manifold 867. The analytical module 800 may include a frame, one or more magnets connected to the frame, a wash manifold connected to the frame, a detector connected to the frame, and a linear positioning stage (for example, linear stage 803) connected to the frame.

FIG. 8B-8C depicts a shuttle that holds reaction vessels according to one or more embodiments FIG. 8B depicts the front of a reaction-vessel-shuttle with the reaction vessels (RVs) withdrawn from their corresponding slots in the shuttle, according to one or more embodiments. The shuttle may have slots for one RV, two RVs, three RVs, four RVs, five RVs, six RVs, seven RVs, or 8 RVs. Shuttle 801 may be configured to connect with linear stage 803 with shuttle mounting flange 831. Shuttle 801 may include shuttle mounting flange 831, reaction vessel slots 819, heater 827, shuttle front wall 829, reaction vessel 821, reaction vessel 822, reaction vessel 823, reaction vessel 824, reaction vessel 825, and reaction vessel 826. The shuttle 801 may be thermally conductive and may have a heating element attached configured to heat the shuttle (for example, heater 827), and so heat the reaction vessels and their contents to a desired temperature. The shuttle may have a flange affixed to a linear stage.

FIG. 8C depicts a back side of a reaction vessel shuttle with the reaction vessels inserted into their corresponding slots in the shuttle, according to one or more embodiments. Shuttle 801 may include belt clamp 833, position sensor 835, shuttle recess 837, and shuttle back wall 839. The backside of the shuttle (for example, shuttle back wall 839) may have a recess (for example, shuttle recess 837) that exposes the bottoms of the reaction vessels. The shuttle may have a belt-clamp (for example, belt clamp 833) configured to attach the shuttle to a timing belt that drives the linear motion of the shuttle. The shuttle may have a sensor (for example, position sensor 835) that can be used in concert with a static flag mounted to the base, to define a position along the base and allow the shuttle to move to a known location.

FIG. 8D shows an isometric view of a wash manifold assembly according to one or more embodiments. Wash manifold assembly 841 may include wash manifold 851, position sensor 853, and vertical support bracket 855. Wash manifold 851 may include waste output holes 845, dispense probe 847, aspirate probe 849, and wash fluid input 857. The wash manifold 851 may include at least one dispense probe 847 and aspirate probe 849, and may include a plurality of dispense and aspirate probes. One or more aspirate and dispense probes may come in pairs, and the number of pairs may be equal to the number of reaction vessel slots in the shuttle. One or more aspirate probes may be slightly longer than the dispense probes. The wash manifold may include a separate aspirate-output hole for each aspirate probe. Wash manifold assembly 841 may translate up and down on vertical rails 843 when driven by a motor through a linkage mechanism. Wash manifold assembly 841 may include a position sensor (for example, position sensor 853) that detects when the wash manifold is in an up or down position.

FIG. 8E-8F show front views of two states of a wash manifold assembly, according to one or more embodiments.

FIG. 8E shows the wash manifold assembly 841 in an up position, disengaged from the RVs in the shuttle below it according to one or more embodiments.

FIG. 8F shows the wash manifold assembly 841 in a down position, engaged from the RVs in the shuttle below it according to one or more embodiments. In this position, the aspirate probe may reach almost to the bottom of its corresponding reaction vessel.

FIGS. 8G-8J show details of the process by which the wash manifold dispenses and aspirates wash fluid into and out of an RV in the shuttle, according to one or more embodiments.

FIG. 8G shows a close-up view of one channel in the wash manifold when the wash manifold is engaged with the shuttle, and the reaction vessel of this channel is empty, according to one or more embodiments. FIG. 8G shows an empty reaction vessel. Reaction vessel 821 may include dispense probe 847 and aspirate probe 849 in a down position within the reaction vessel 821.

FIG. 8H shows a close-up view of one channel in the wash manifold when the wash manifold is engaged with the shuttle, and the dispense probe of the wash manifold channel is dispensing fluid into the reaction vessel below it, according to one or more embodiments. FIG. 8H shows a wash process starting. Dispense probe 847 may dispense fluid 859 into reaction vessel 821. Fluid 859 may be a wash fluid. All of the wash probes may be connected in parallel to a wash channel in the manifold that is fed by a wash pump (not shown) that drives fluid through the wash fluid input hole into the wash channel. The wash channel may have a larger inner diameter than the dispense probes, and the pump may push at a flow-rate fast enough that a substantially equal pressure drop occurs across each of the dispense probes, causing substantially the same amount of fluid to be dispensed through each of the parallel wash probes during dispense operations.

FIG. 8I shows a close-up view of one channel in the wash manifold when the wash manifold is engaged with the shuttle, and the dispense probe has filled the reaction vessel below it with a volume of fluid, according to one or more embodiments. Reaction vessel 821 may be filled with volume of fluid 861. Volume of fluid 861 may be the same fluid as fluid 859, and may be a wash fluid.

FIG. 8J shows a close-up view of one channel in the wash manifold when the wash manifold is engaged with the shuttle, and the aspirate probe has pulled almost all the liquid out of the reaction vessel below it, according to one or more embodiments. Fluid 863 may be pulled out of the reaction vessel 821 by an aspiration probe like aspirate probe 849. The aspirate probe (for example, aspirate probe 849) may be fluidically connected to an individual waste output hole 865, which may be connected by tube to a waste pump (not shown). The aspirate probe (for example, aspirate probe 849) may be centered or nearly-centered on a deeper part of the reaction vessel, or the deepest part of the reaction vessel, and the aspiration probe may be close to bottom of the reaction vessel, so that an aspiration pulls all or nearly all of the fluid out of the reaction vessel.

FIGS. 8K-8L shows views of a magnet manifold assembly, according to one or more embodiments.

FIG. 8K shows a partially-exploded view of the magnet manifold assembly, according to one or more embodiments. Magnet manifold 867 may be a magnet manifold assembly. Magnet manifold 867 may include front magnet 869, middle magnet 871, and back magnet 873. More than one magnet may be used together to generate a desired magnetic force and form-factor. For instance, two large cylindrical magnets (for example, middle magnet 871 and back magnet 873) may be stacked end-to-end to generate a large magnetic force, and a smaller cylindrical magnet (for example, front magnet 869) may be placed on top of them to concentrate the force to a smaller area.

Alternatively, a single magnet of appropriate size and magnetic field strength may be used. The magnets in the magnet manifold 867 may be rare-earth magnets or electromagnets. The magnets in the magnet manifold 867may be chosen to be strong enough such that when the shuttle is positioned proximally to the magnetic manifold, the magnetic field strength of the magnets is sufficient to cause substantially all of the magnetic beads within the reaction vessels to form a pellet within thirty seconds.

FIG. 8L shows a collapsed view of the magnet manifold assembly, according to FIG. 8K. Magnet manifold 867 may include magnetic assembly positioning slots 875 and wash bracket mounting holes 877. The magnet manifold 867 may have an array of magnets (or stacks of magnets) and may have at least as many channels in the array of magnets as there are reaction vessels.

FIGS. 8M-8P shows the immunoassay module with the shuttle located in different functional positions according to one or more embodiments. Module 800 may have one or more functional positions including loading reaction vessels; shake, read or add reagents; pellet/wash arm up; and pellet and wash/wash arm down.

FIG. 8M shows the immunoassay module with the shuttle located in the load-RV position, according to one or more embodiments.

FIG. 8N shows the immunoassay module with the shuttle located in a position where the shuttle may shake aggressively back-and-forth, or alternatively where a system pipettor may dispense liquids into and out of an RV, or, alternatively, where the shuttle may be moved in front of a light-detector, according to one or more embodiments. Here system pipette 887 may dispense liquids into one or more reaction vessels. When the shuttle is moved to the light-detector position, the recess in the back of the shuttle (as shown in FIG. 8C) may enable the detector to nearly-touch the surface of the reaction vessels. The reaction vessels may be translated so that a surface of a reaction vessel abuts the front face of the detector.

FIG. 8O shows the immunoassay module with the shuttle located in a position in front of the magnet assembly with the wash manifold in the up position where magnetic beads may be pelleted, according to one or more embodiments. When the shuttle is moved to the magnet-manifold position, the recess in the back of the shuttle (for example, as seen in FIG. 8C) may enable the reaction vessels in the shuttle to nearly-touch the front of the magnets. The reaction vessels may be translated so that the reaction vessels abut the magnets.

FIG. 8P shows the immunoassay module with the shuttle located in a position in front of the magnet assembly with the wash manifold in the down position, where magnetic beads may be pelleted and washed, according to one or more embodiments. In this position the magnets may attract any magnetic beads to one side of the reaction vessels, and wash fluid may be dispensed into and aspirated out of the reaction vessels, such as is shown in FIG. 8G-8J. The repeated dispense and aspirate cycles may be used to wash the magnetic beads pinned against the side of the reaction vessels.

FIGS. 8Q-8S show the immunoassay module in an enclosure and certain features of the enclosure, according to one or more embodiments.

FIG. 8Q shows the enclosure around the immunoassay module, according to one or more embodiments. Here the analytical immunoassay module may include an enclosure 879. Enclosure 879 may be a housing configured to partially or fully enclose an analytical immunoassay module (for example, module 800). Enclosure 879 may be an enclosure defining an interior volume within which an immunoassay module is disposed.

FIG. 8R shows a transparent view of the enclosure, showing the immunoassay module inside it, according to one or more embodiments.

FIG. 8S is a detailed view of a portion of the immunoassay module enclosure, showing a sliding cover, driven by an actuator, configured to open and close a pipette access port, according to one or more embodiments. Enclosure 879 may include actuator 881, sliding cover 883, and pipette access port 885 for access by system pipette 887. The sliding cover may be driven by a solenoid. Other mechanical means may be used to position a cover over the pipette access port. For example, a sliding, or hinged cover may be driven by a motor and cam, or by a linear actuator, such as a solenoid, lead-screw or timing belt. The cover may be off, and the pipette access port 885 open when a system pipettor needs to access the reaction vessels in the shuttle for example, when the pipettor adds reagents to the reaction vessels. The cover may be closed during detector reads, or when ambient light must be minimized.

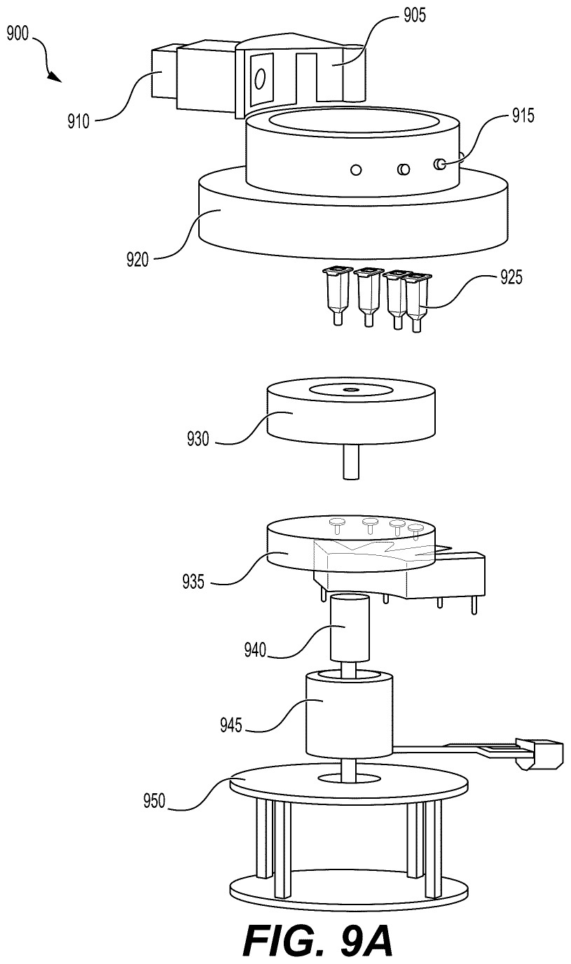

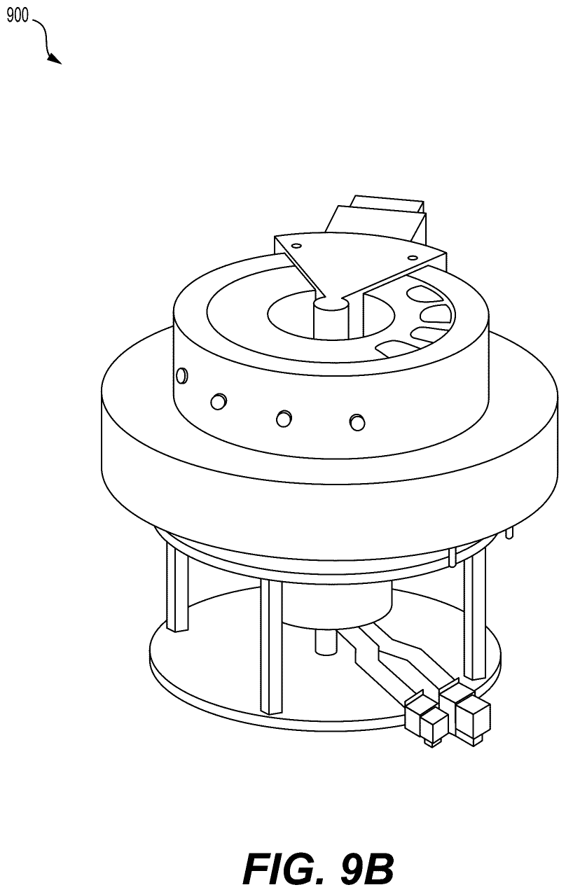

FIGS. 9A-9B show an analytical module that uses reaction vessels with an input and output, according to one or more embodiments. The output of each reaction vessel is fluidically connected to a normally closed valve.

FIG. 9A depicts an exploded view of the analytical module, according to one or more embodiments. Module 900 may include shroud 905, detector 910, magnets 915, housing 920, reaction vessels 925, rotating heatblock 930, rotating shuttle with valves 935, motor coupler 940, motor 945, and stand 950.

FIG. 9B depicts a collapsed view of the analytical module, according to FIG. 9A. Module 900 may include shroud 905, detector 910, magnets 915, housing 920, reaction vessels 925, rotating heatblock 930, rotating shuttle with valves 935, motor coupler 940, motor 945, and stand 950, as seen for example in FIG. 9A.

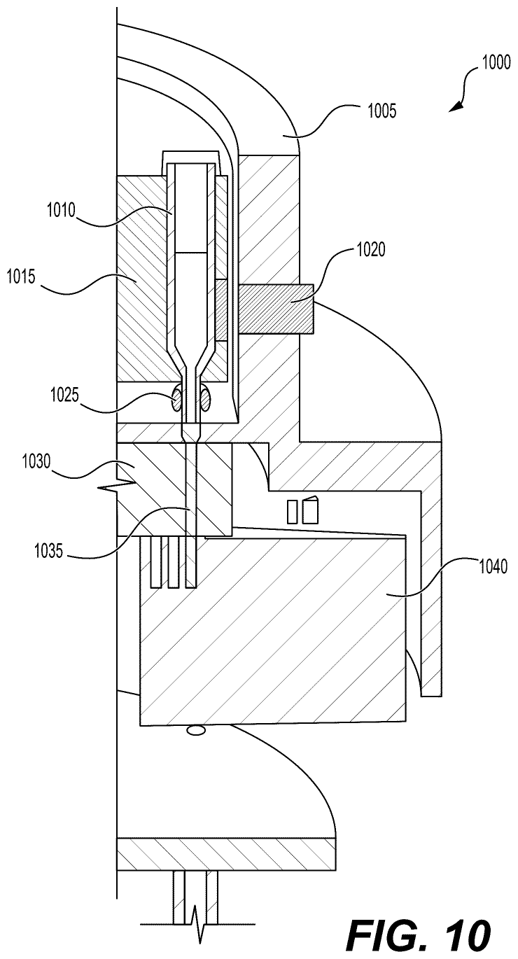

FIG. 10 shows a cross-sectional view of a portion of an analytical module that has reaction vessels with an input and an output-drain. The output of the reaction vessel connects to a fluidic path in a manifold that is gated by a valve. Module assembly 1000 may be a module like module 900 in a cross-sectional view. Module assembly 1000 may include housing 1005, reaction vessel 1010, heatblock 1015, magnet 1020, O-ring 1025, manifold 1030, waste channel 1035, solenoid valve 1040.

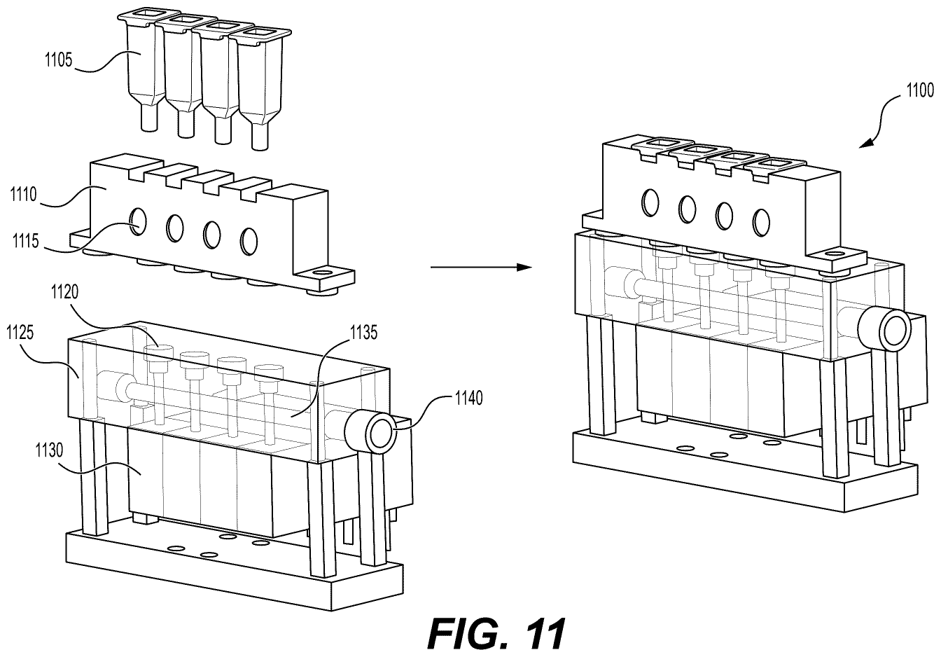

FIG. 11 shows a fluidic sub-assembly of an exemplary embodiment of the analytical module where the analytical module is a linear immunoassay module, according to one or more embodiments. The sub-assembly 1100 may include reaction vessels 1105, heatblock 1110, magnet holes 1115, O-rings 1120, manifold 1125, valves 1130, waste channel 1135, and fluidic fitting 1140. Sub-assembly 1100 may hold and heat the reaction vessels, and sub-assembly 1100 may enable fluids to be added to and drained from the reaction vessels. Sub-assembly 1100 may include one or more O-rings 1120 configured to form liquid-tight seals with the outputs of the reaction vessels 1105, creating passages between the output of the reaction vessels 1105 and the manifold 1125. One or more valves 1130 may be connected to the manifold 1125, where the valves 1130 are gating the outputs of the reaction vessels 1105 such that when the valves 1130 are closed, the reaction vessels cannot drain, but when the valves 1130 are open, the outputs of the reaction vessels 1105 are connected through the valves 1130 to waste channel 1135.

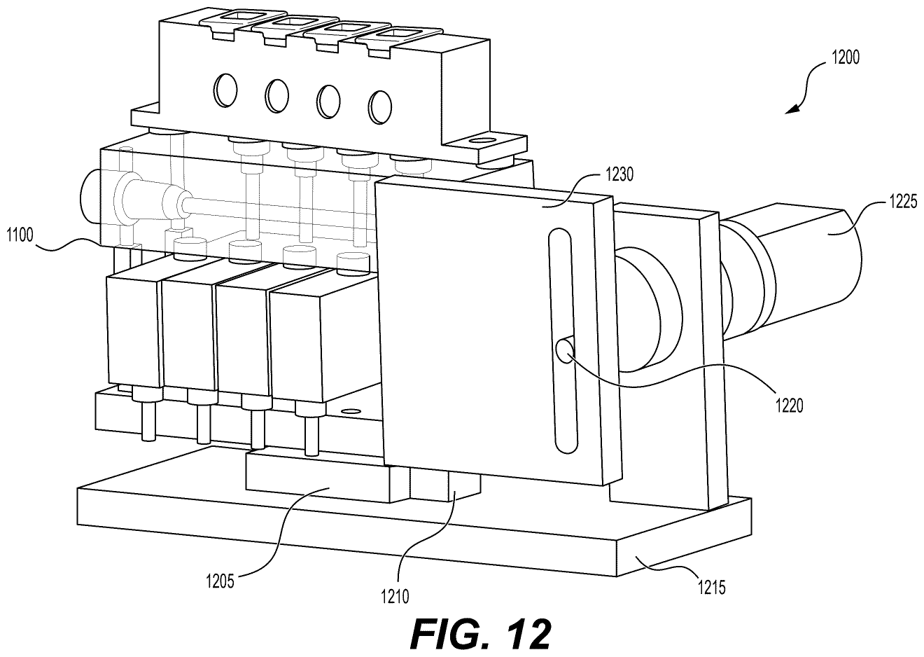

FIG. 12 shows a shaking sub-assembly responsible for shaking the reaction vessels of a linear immunoassay analytical module, according to one or more embodiments. Sub-assembly 1200 may include sub-assembly 1100. Module 1200 may include linear stage carriage 1205, linear rail 1210, base 1215, scotch yoke pin 1220, shake motor 1225, and scotch yoke follower 1230.

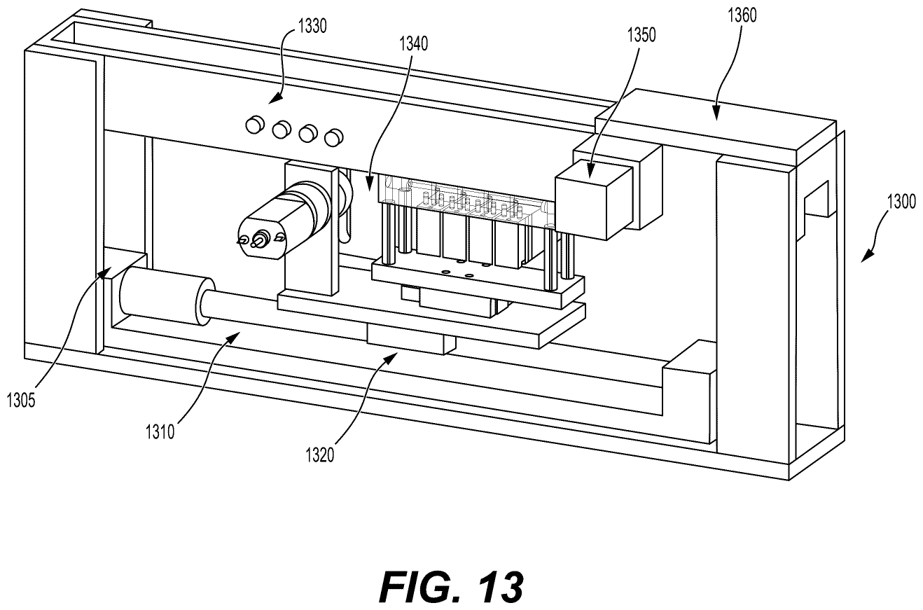

FIG. 13 shows an analytical module in which the functions of aggressive shaking and accurate-positioning have been separated, according to one or more embodiments. Linear immunoassay module 1300 may include linear translation motor 1305, linear translation stage rail 1310, linear translation stage carriage 1320, magnets 1330, immunoassay shaker sub-assembly 1340, detector 1350, and cover 1360.

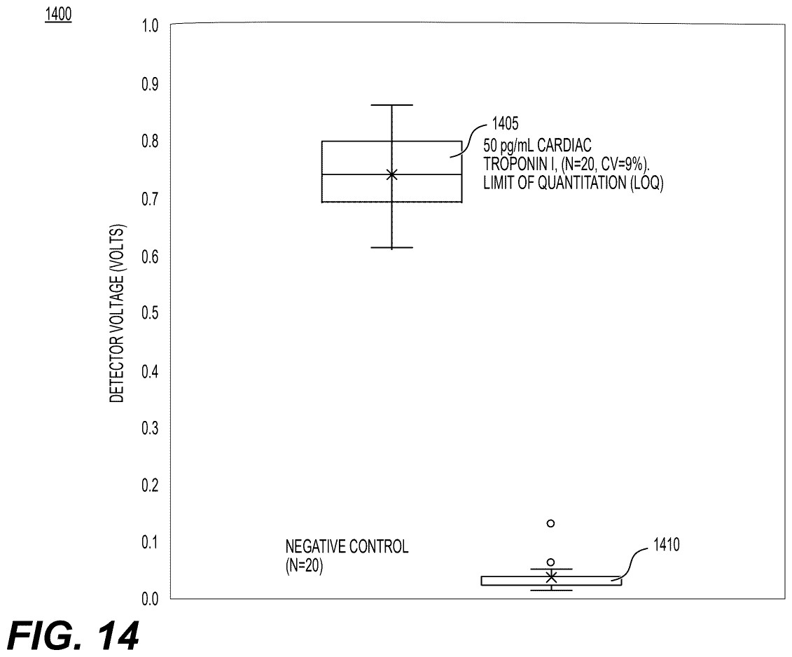

FIG. 14 shows a box and whisker plot showing exemplary results of an immunoassay performed on the analytical module, according to one or more embodiments. This FIG. 1400 may include data 1405 and data 1410, from N=20 tests with cardiac troponin I, and depicts a limit-of-quantitation equal to 50 picograms per milliliter (pg/mL) (CV=9%) cardiac troponin I and a calculated limit-of-detection equal to 4 picograms per milliliter of cardiac troponin I.

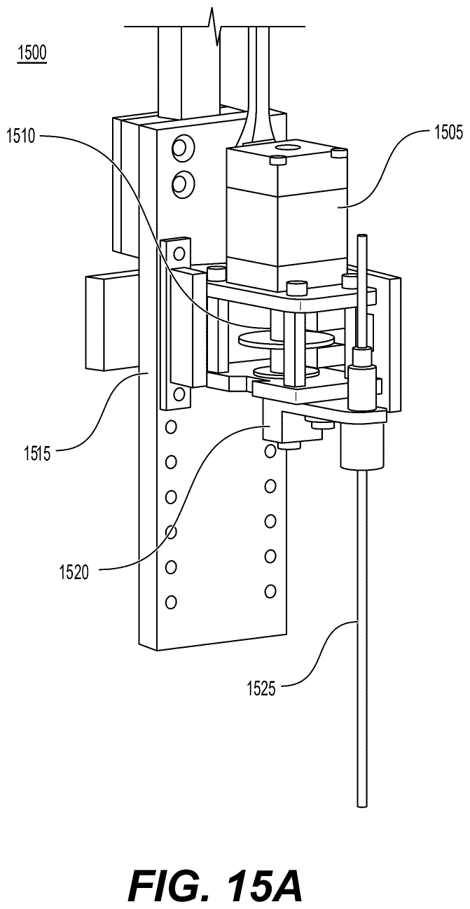

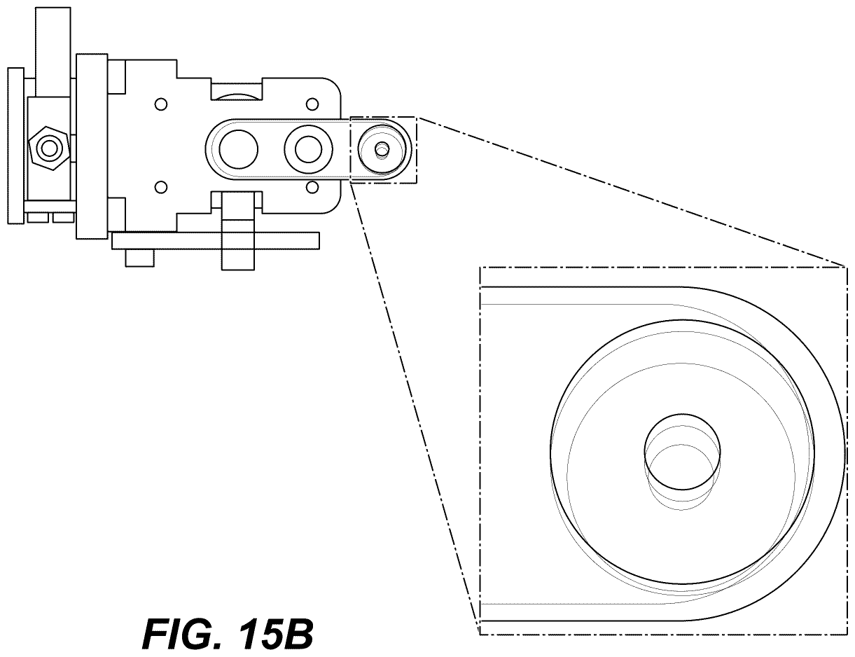

FIG. 15A shows an isometric view of a pipettor, according to one or more embodiments. System 1500 may be a stir-pipettor. System 1500 may include motor 1505, coupler with eccentric hole 1510, mounting bracket 1515, flange 1520, and pipette 1525. Alternatively, system 1500 may be a simple pipette, not a stir pipettor. For example, the immunoassay module described herein may not stir with the pipettor, and instead may shake the reaction vessels.

FIG. 15B shows a bottom view of the stir-pipettor with a zoomed-in view of the pipette as it is moved in a circular arc, according to one or more embodiments.

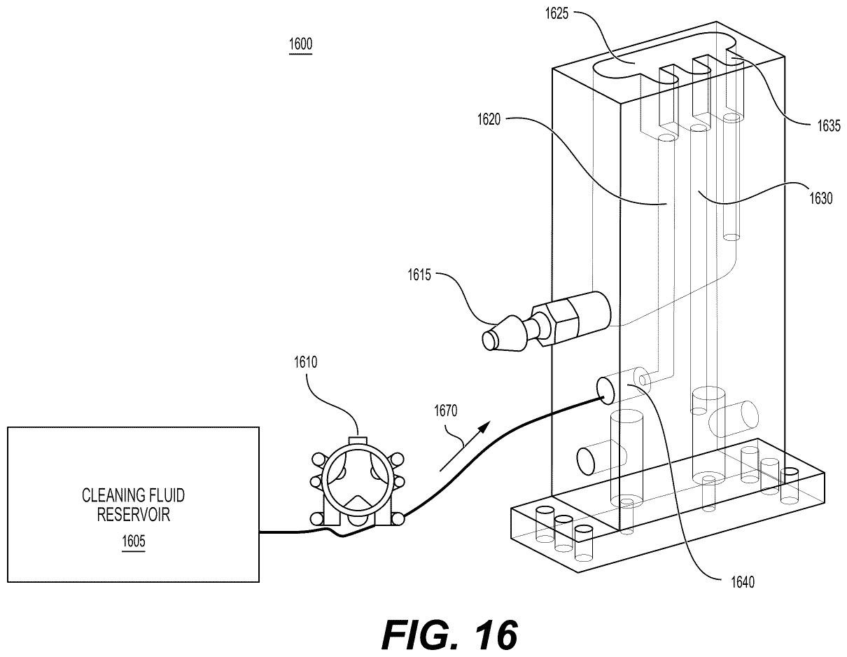

FIG. 16 shows a waste/wash station of the fluidic system of the systems described herein, according to one or more embodiments. System 1600 includes cleaning fluid reservoir 1605, cleaning pump 1610, waste output 1615, extra-cleaning fluid hole 1620, small waste reservoir 1625, deep cleaning hole 1630, shallow cleaning hole 1635, cleaning fluid input 1640, fluid flow 1670.

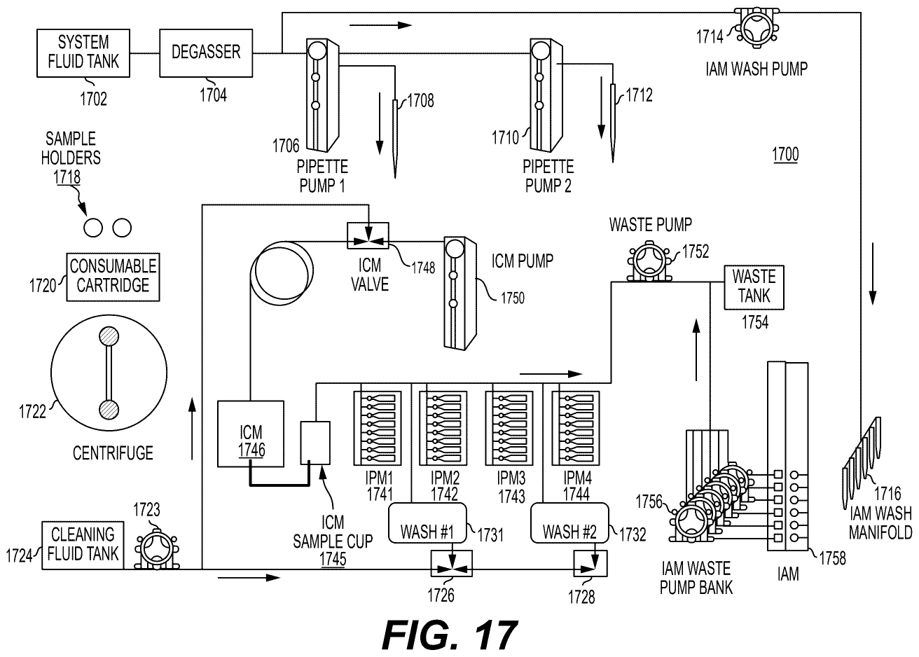

FIG. 17 shows the fluid architecture of an exemplary system of the present disclosure, according to one or more embodiments.

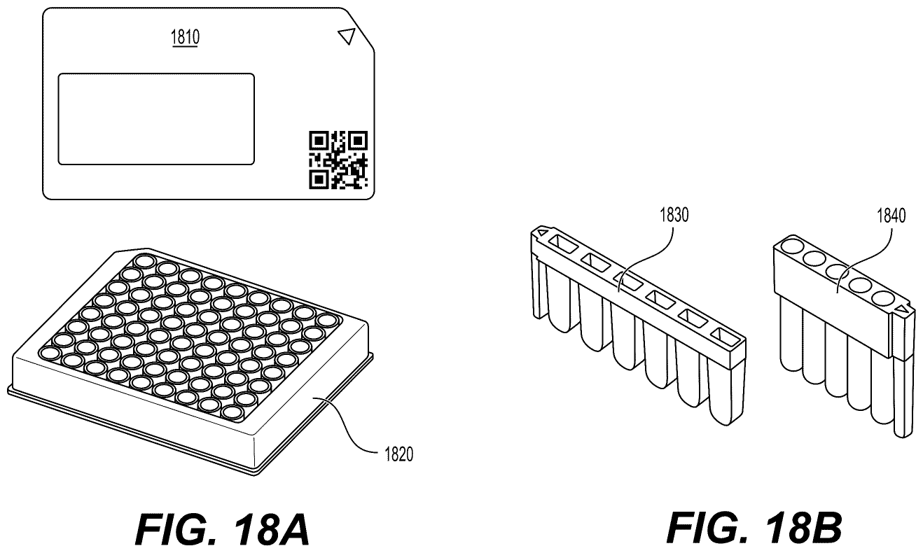

FIG. 17 shows a system containing the integrated analytical module (IAM) that is the subject of this disclosure, according to one or more embodiments. System 1700 may include IAM 1758, IAM waste pump bank 1756, IAM wash manifold 1716, and IAM wash pump 1714. System 1700 may also include other analytical modules, such as integrated photometry modules (IPMs): IPM one 1741, IPM two 1742, IPM three 1743, IPM four 1744, which enable photometric (absorbance and fluorescence) assays and may be useful in analysis of chemistry analytes, and integrated cytometry module (ICM) 1746, which includes the ICM sample cup 1745, ICM valve 1748, and ICM pump 1750, and which may enable cell-based assays. Regardless of whether additional modules such as IPMs and ICMs are present, the IAM and other modules are supported by system-level hardware that may include system fluid tank 1702, degasser 1704, pipette pump one 1706, pipette one 1708, pipette pump two 1710, pipette two 1712, sample holders 1718, consumable cartridge 1720, centrifuge 1722, cleaning fluid tank 1724, pump 1723, valve 1726, valve 1728, waste/wash station one 1731, waste/wash station two 1732, waste pump 1752, and waste tank 1754, FIGS. 18A-18B depict cartridges, reaction vessels, and reagent vessels, according to one or more embodiments. FIGS. 18A-18B may include consumables, for example, according to one or more embodiments.

FIG. 18A shows a cartridge that resembles a well-plate, according to one or more embodiments. FIG. 18A shows the cartridge 1810 that resembles a well-plate. The cartridge 1810 is illustrated with a seal, such as a foil-seal covering the wells, and a cartridge 1820 is illustrated with the seal removed. The cartridge 1810 may contain reagents needed for immunoassays performed in the immunoassay module of the present disclosure. Alternatively, cartridge 1810 may contain reagents needed for assays that do not use the immunoassay module, such as clinical chemistry and hematology assays.

FIG. 18B shows reaction vessels and reagent vessels, according to one or more embodiments. The system may include individual reaction vessels and reagent vessels, or as shown for example in FIG. 18B may instead comprise a monolithic strip of reaction vessels 1830 and a monolithic strip of reagent vessels 1840. In some embodiments reagent vessels 1840 are separate from the reagent cartridge 1810. Reagent vessels 1840 are integrated with reagent cartridge 1810.

Each reaction vessel in the reaction vessel strip 1830 may contain magnetic beads with antibodies specific to a particular analyte and the reagent vessel strip 1840 may contain the additional reagents necessary to perform the immunoassays. For example, the reagent vessel strip may contain enzyme-linked detector antibodies, specific to each analyte, and may further contain a chemiluminescent substrate that can be activated by the enzyme linked to the detector antibodies.

The module described herein may be embedded within a larger instrument, and may therefore leverage durable system-level hardware including a wash fluid tank, a cleaning fluid tank, pipettors, and a waste-collection reservoir. The ability to utilize durable system-level hardware means that the size and complexity of the consumables is reduced. For example, a single immunoassay may be performed using just one reaction vessel (containing beads with bound antibody) and two reagent vessels (a first reagent vessel containing the enzyme-linked detector antibody, and a second reagent vessel containing the chemiluminescent substrate). The remaining reagents necessary to perform an immunoassay, including cleaning solutions and wash solutions, may be delivered through system-level hardware, either by transfer through the wash manifold or through the external pipettor.

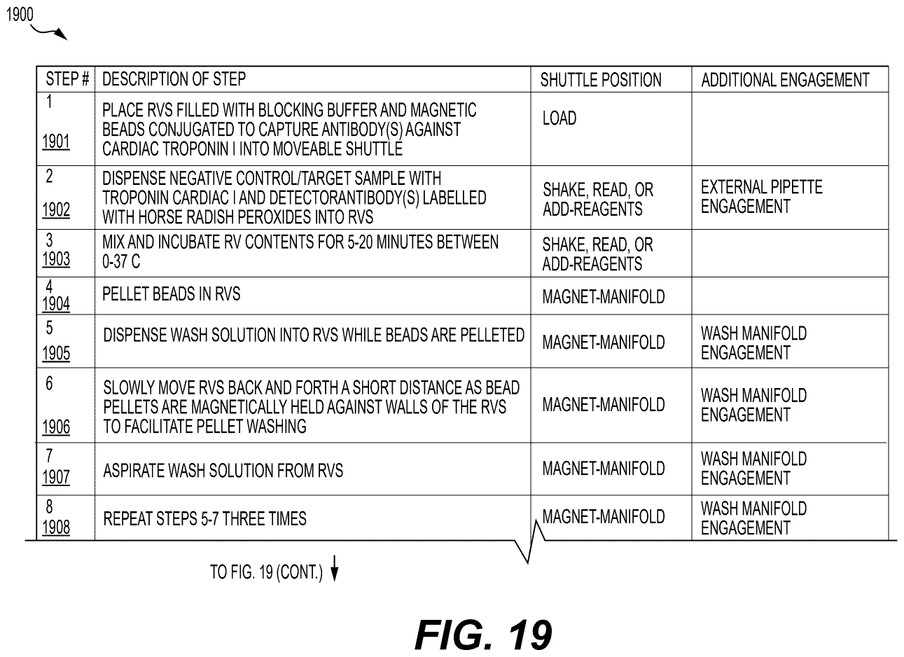

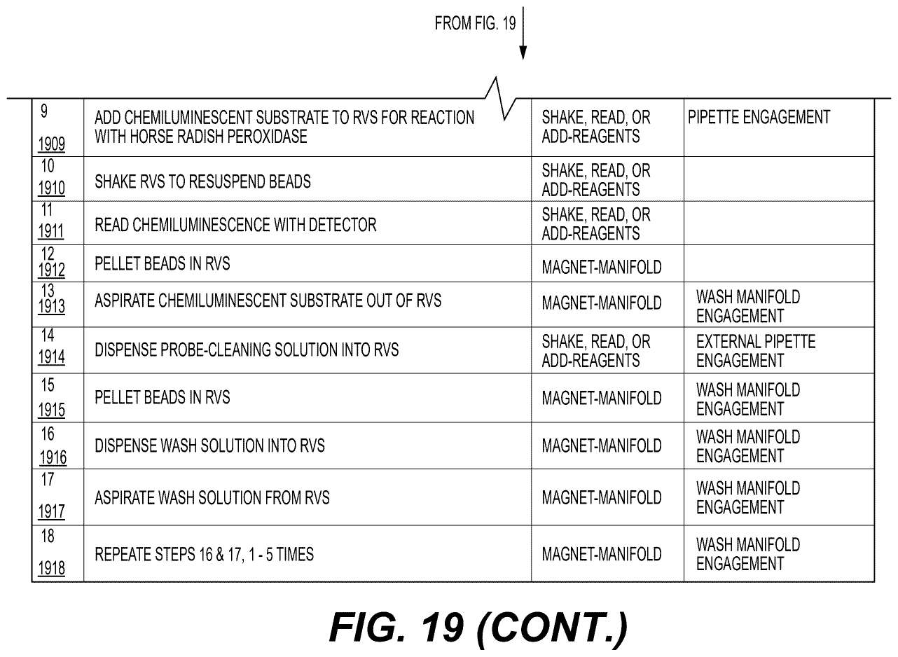

FIG. 19 depicts a table of steps that may be used to perform a magnetic-bead-based immunoassay and the associated positions that may be used to conduct those steps, according to one or more embodiments. Table 1900 may include operation 1901, operation 1902, operation 1903, operation 1904, operation 1905, operation 1906, operation 1907, operation 1908, operation 1909, operation 1910, operation 1911, operation 1912, operation 1913, operation 1914, operation 1915, operation 1916, operation 1917, and operation 1918. Each operation may include a step to be performed, a shuttle position, and a note of any additional engagement that the reaction vessels have with an external pipettor or wash manifold.

Operation 1901 may include placing RVs filled with blocking buffer and magnetic beads conjugated to capture antibody(s) against cardiac troponin I into the movable shuttle when the shuttle is in the load position.

Operation 1902 may include dispensing sample and/or a negative control with troponin cardiac I and detector-antibody(s) labelled with horse radish peroxidase into the reaction vessels when the shuttle is in the shake-read-or-add-reagents position, and an external pipettor is engaged.

Operation 1903 may include mixing and incubating the reaction vessel contents for a period of time at a particular temperature. In some embodiments the mixing is performed by shaking the shuttle back and forth vigorously. In some embodiments the mixing is performed for 10 minutes at 37 degrees Celsius.

Operation 1904 may include pelleting beads in the reaction vessels when the shuttle is in front of the magnetic-manifold assembly.

Operation 1905 may include dispensing wash solution into the reaction vessels while the shuttle position remains at the of magnet manifold, and the wash manifold is in the down (engaged) position.

Operation 1906 may include slowly moving the shuttle back and forth a short distance in the magnet-manifold position, as bead pellets are magnetically held against walls of the reaction vessels to facilitate pellet washing.

Operation 1907 may include aspirating wash solution from RVs while the shuttle is in the magnet-manifold position and the wash manifold remains in the down (engaged) position.

Operation 1908 may include repeating operations 1905-1907. In some embodiments the operations are repeated 5-7 times.

Operation 1909 may include moving the shuttle to a location where external pipette engagement is possible, and using the pipette to dispense a chemiluminescent substrate to the RVs for interaction with an enzyme. In some embodiments the enzyme is horseradish peroxidase.

Operation 1910 may include mixing and incubating the reaction vessels for a period of time at a given temperature. In some embodiments the shuttle is in a position where it can shake back-and-forth vigorously to enable the mix. In some embodiments the mixing and incubation occurs for anywhere from 5 to 20 minutes at a temperature of 30 to 37 degrees Celsius.

Operation 1911 may include reading the chemiluminescent signal in the reaction vessels with the detector while the shuttle is in the read position. In some embodiments the detector may sequentially read the signal from all the reaction vessels in the shuttle.

Operation 1912 may include moving the shuttle to the magnetic manifold position and pelleting the beads in the reaction vessels.

Operation 1913 may include aspirating chemiluminescent substrate out of the reaction vessels using the wash manifold.

Operation 1914 may include using the external pipette tip to dispense probe-cleaning solution into the reaction vessels while the shuttle is in the add-reagents position. Operation 1915 may include moving the shuttle back to the magnet-manifold and pelleting the beads in the reaction vessels.

Operation 1916 may include engaging the wash-manifold with the reaction vessels and dispensing wash solution into the reaction vessels while the beads remain pelleted.

Operation 1917 may include aspirating wash solution from the vessels while the beads remain pelleted. Operation 1918 may include repeating operations 1916 and 1917 a certain number of times. In some embodiments the operations are repeated from one to five times.

### Analytical (e.g., Immunoassay) Module

Aspects of the present disclosure include an analytical module (used interchangeably herein as “immunoassay module”). In some embodiments, the analytical module can perform various immunoassays from one or more samples.

In one embodiment, the analytical module comprises a rotating shuttle. In some embodiments, the rotating shuttle is mounted to the shaft of a motor, which in turn is supported by a stand. In some embodiments, the rotating shuttle has a plurality of cavities, shaped to receive disposable or reusable reaction vessel(s) (RVs). These RVs may be of any shape, size or material. In some embodiments the RVs may have a substantially flat side. In some embodiments the shuttle may be made of plastic or may be made of a thermally conductive material such as a ceramic or metal. In certain embodiments, if the shuttle is made from a thermally conductive material, heating and cooling elements may be included.

In some embodiments, the analytical module comprises a housing that surrounds the rotating shuttle or. In some embodiments, the housing may have a plurality of holes, adapted to receive magnets, so that one pole of each magnet is positioned next to the rotating shuttle without interfering with its movement. In some embodiments, the relative number and ordinal positions of magnets and RV positions can vary to coordinate pelleting and resuspension of magnetic beads per blocks of RVs. For example, there can be one magnet for each RV position or one magnet for every other RV. In some embodiments, the array of north/south magnet poles can be arranged in multiple patterns (e.g., north/north/north, south/north/south) for best configuration of magnetic fields in a compact instrument space. In some embodiments, the holes and the magnets they receive may be cylindrical, but they may also be of any other shape, such as a rectangle or a square (FIG. 1A).

In some embodiments, the housing may have a position sensor fixed to it, which interacts with a corresponding flag on the rotating shuttle to provide absolute position information. This sensor may be a Hall sensor, an optical-interrupt sensor, or any other position-sensitive sensor such as are known in the art.

In some embodiments, the analytical module comprises a shroud that is mounted over the top of the housing and rotating shuttle. In some embodiments, the shroud is made of opaque material and has a top that partially covers the shuttle and housing. In some embodiments, the shroud also has a cavity shaped to receive a detector such as a photomultiplier tube or avalanche photo diode.

In some embodiments, during operation of the analytical module, the shuttle is free to rotate along a pre-determined arc between 0 and 360 degrees. In some embodiments, the reaction vessels may be positioned at various locations during travel as illustrated in FIGS. 2A-2E. Nonlimiting examples of the positions are thus further described for FIGS. 2A-2E below.

In one position of the shuttle, the magnet(s) in the housing are engaged with reaction vessels (RVs). As illustrated, there is one magnet for each RV, so that when the shuttle is positioned as shown, each RV interacts with a magnet. However, the shuttle may also be incrementally rotated so that fewer RVs are engaged with magnets at any given time. Furthermore, it is not necessary that every hole in the housing be populated with a magnet. Thus, depending on the number of magnets held in the housing, and the precise location of the shuttle, one or more RVs may be engaged to interact with magnets in this location. The tops of the RVs are free from obstruction, so in this position reagents for assays may be added to or removed from each RV for instance by a pipettor.

In another position of the shuttle, the RVs are disengaged from the magnets and their tops are free of obstruction. In this position, reagents for assays may be added to or removed from each reaction vessel for instance by a pipettor.

In another position of the shuttle, one of the RVs is aligned with a detector so that the detector may receive a signal from the RV. For instance, the detector may be a photomultiplier tube that receives light from a chemiluminescent reaction occurring in the RV. With incremental rotation of the shuttle, each RV can be positioned in front of the detector in turn. A shroud helps protect the detector from ambient light. In this position, a pipettor has limited access to the top of the RVs.

In another position of the shuttle, the RVs may be shaken through rapid back-and forth movement of the motor at a location that is far away from the magnets. It is a unique aspect of the present disclosure that the rapid back-and-forth motion of the motor may shake the RVs in such a way as to cause their contents to be mixed, and/or to cause pelleted beads within the RV to be resuspended in solution.

Another non-limiting example of the analytical module is shown in FIGS. 3A-3B. FIG. 3A shows an exemplary model of the analytical module containing an extra slot for a vertically mounted detector, which could be useful for example to detect fluorescent signal generated by an excitation signal impinging on the cuvette from a horizontal axis.

### Mechanical Motion for Mixing and Suspension of Particulates:

Another aspect of the analytical module includes its configuration to allow for shaking the shuttle back and forth to enable mixing of reagents and suspension of particulates, including resuspension of particles such as cells or magnetic beads. In some embodiments, the analytical module is configured to shake the shuttle back and forth through rapid directional switching of the motor.

In some embodiments, the size and/or shape of the reaction vessel influence the type of mixing in the analytical module that occurs. Such mixing in the analytical module can include, but is not limited to sloshing or swirling. In some embodiments, the size and shape of the reaction vessel affect the mixing efficiency and/or speed of the analytical module.

In some embodiments, the position of the reaction vessels within the shuttle influences the type of mixing in the analytical module that occurs. In some embodiments, the position of the reaction vessels within the shuttle affects the efficiency and/or speed of mixing in the analytical module.

In some embodiments, the velocity and acceleration of the motor influences the type of mixing in the analytical module that occurs. In some embodiments, the velocity and acceleration of the motor affect the efficiency and/or speed of mixing in the analytical module.

In some embodiments, the frequency of direction-shift/number of back-and-forth oscillations per second influences the type of mixing in the analytical module that occurs. In some embodiments, the frequency of direction-shift/number of back-and-forth oscillations per second affects the efficiency and/or speed of mixing in the analytical module.

In some embodiments, one or more parameters influences the type of mixing in the analytical module and/or affects the mixing efficiency and/or speed of the analytical model. In some embodiments, the one or more parameters are selected from: the size and/or shape of the reaction vessel; the position of the reaction vessels within the shuttle; the velocity and/or acceleration of the motor; and the frequency of direction-shift/number of back-and-forth oscillations per second.

FIGS. 4A-4C shows the rotating shuttle during a mixing/particle-resuspension operation. To enable visualization of the reaction vessels, the housing and shroud have been removed from the module. The parameters used for this operation were:
Reaction vessel: 11 mm×6.4 mm×39.6 mm
Motor speed: 5000 rpm
Motor acceleration: 25000 rpm/second
Frequency of oscillations: 7/second In this example, with this thin narrow RV, mixing is achieved through sloshing rather than swirling typical of more rounded RVs. With these parameters, complete mixing was achieved in 6 seconds per visual observation.

In some embodiments, different tasks may be accomplished by controlling these parameters.

### Spring Assistance

In some embodiments, when the shuttle oscillation is of a known, narrow band frequency range, oscillation can be assisted by a spring having a spring constant K tuned to the effective sprung mass of the shuttle. In some embodiments, like a 1-D spring/mass system, this spring/shuttle assembly may have a resonant frequency that can be driven by a low power motor, resulting in a system that consumes less power, generates less heat, and has a longer life expectancy than an un-sprung system. Care must be taken to choose a motor that can position and hold the shuttle at desired positions for desired times.

### Thermal Control

In some embodiments, the analytical module is configured to provide thermal control. In some embodiments, one or more immunoassays used in the analytical module benefit from a tightly controlled thermal environment. In some embodiments, the shuttle of the analytical module as shown in FIGS. 1A-1B and FIGS. 2A-2E may be made from a thermally conductive material, such as, but not limited to: aluminum or ceramic. In some embodiments, the analytical module comprises heating or cooling elements that may be affixed to the shuttle so that they heat or cool the shuttle, which thereby heats or cools the RVs and their contents.

In some embodiments, the analytical module comprises one or more temperature-control elements. In some embodiments, the one or more temperature-control elements is selected from: flexible film heaters, cartridge heaters, Nichrome wire heaters, Peltier devices, and fluid-filled tubes. In some embodiments, the one or more temperature control elements may be integrated into the shuttle or adhered to it. In some embodiments, the analytical module comprises a thermistor that may be integrated into or adhered to the shuttle such that it can provide feedback to a closed-loop temperature controller and achieve tight temperature control.

### Wire Management

In some embodiments, the analytical module comprises one or more wires and tubes. In some embodiments, regardless of how heating and cooling is achieved, the analytical module is configured to manage the wires and tubes that power the elements. In the case of a rotating shuttle, these wires are at risk of becoming tangled if the shuttle is permitted to spin freely.

In some embodiments, the shuttle of the analytical module is configured to rotate by an amount or arc of less than 360 degrees (e.g., less than 360 degrees, less than 350 degrees, less than 340 degrees, less than 330 degrees, less than 320 degrees, less than 310 degrees, and the like) as it travels from one position to another, (i.e. the shuttle moves back and forth across an arc of less than 360 degrees; it does not rotate in a full circle).

### Additional Embodiments

In some embodiments, the analytical embodiment comprises a detector for assay analysis. In some embodiments, the detector is a single detector as shown in FIGS. 1A-1B and FIGS. 2A-2E.

In some embodiments, the analytical module comprises a plurality of detectors. In some embodiments, the analytical module comprises one or more of: excitation source(s) and filter wheel(s) as shown in FIG. 5A-5B.

In some embodiments, the analytical module comprises one or more emitters such as a light source. In this embodiment, the emitter may be a light source such as a light-emitting-diode, a laser or a lamp.

In some embodiments, the filter wheel may have wavelength-selective filters, neutral density filters or polarizing filters for detection of desired wavelengths. This arrangement might be used for absorbance or fluorescence-based assays.

### Wash Manifold

In some embodiments, the analytical module comprises a liquid handling mechanism.

In some embodiments, the analytical module comprises a wash manifold. In some embodiments, the analytical module comprises a double probed wash manifold e.g., as shown in FIG. 8D.

In some embodiments, the wash-manifold comprises a multi-channel pipettor. This component may be used to quickly aspirate and dispense liquids into multiple reaction vessels in parallel. In some embodiments, each reaction vessel has a dedicated wash and aspirate probe.

### Linear Embodiments

Another embodiment of the analytical module is shown in FIG. 8. In some embodiments, the analytical module comprises a motor. In certain embodiments, the motor controls a linear stage. In some embodiments, the rotating shuttle is replaced by a translating linear shuttle. In some embodiments, shuttle movement positions RVs near different functional elements and enables mixing and particulate-resuspension through rapid back-and-forth movement of the shuttle. This embodiment is functionally represented in FIG. 8D.

In some embodiments, the analytical module comprises one or more reaction vessels. In some embodiments, the analytical module comprises an array of reaction vessels. In some embodiments, the analytical module comprises a detector with a light-protective shroud. In some embodiments, the analytical module comprises at least one magnet. In some embodiments, the analytical module comprises one or more magnets, two or more magnets, three or more magnets, four or more magnets, five or more magnets, six or more magnets, seven or more magnets, eight or more magnets, nine or more magnets, or ten or more magnets. In some embodiments, the analytical module comprises 15 or more magnets, 20 or more magnets, 25 or more magnets, 30 or more magnets, 35 or more magnets, 40 or more magnets, 45 or more magnets, or 50 or more magnets.

FIGS. 8A-8S show a module with an array of reaction vessels, a detector with a light protective shroud, and at least one magnet.

The analytical module can be used to perform multiple immunoassays on a single sample or perform a single assay on multiple samples. The system can also analyze controls and calibrants. The rotational shuttle or linear shuttle moves RVs to station locations for each immunoassay step.

In some embodiments, oscillation of the linear stage can be assisted by a spring tuned to the desired oscillation frequency.

### Valved Reaction Vessels

In some embodiments, the analytical module comprises one or more reaction vessels. In some embodiments, the analytical module comprises an array of reaction vessels.

In some embodiments, the reaction vessels comprise a single opening at the top through which reagents are pipetted. However, the reaction vessels may also include an input and output. FIG. 9A-9B illustrates such an embodiment. The functional elements are the same as those of the embodiment shown in FIG. 1A-1B, and the operative steps are identical to those shown in FIG. 2A-2E. However, in this embodiment, each reaction vessel has an output that is fluidically coupled to a corresponding valve in a manifold. In some embodiments, the analytical module comprises a manifold. In some embodiments, the manifold comprises a valve. In some embodiments, liquid is contained in the reaction vessel when the valve is closed.

In some embodiments, a waste pump can pull contents of a reaction vessel to waste when the valve is opened. In certain embodiments, the analytical module or fluidic system in which the analytical module is included comprises a waste pump.

FIG. 10 is a detailed view of how the reaction vessel, in one embodiment, sits in the heat block and is fluidically coupled to an underlying manifold through a radial O-ring seal. In this exemplary architecture, the waste channel in the manifold leads to a valve that connects the waste channel to a waste pump (not shown), enabling the contents of the reaction vessel to be pulled to waste on-demand.

Having an output port in the reaction vessel separate from its input is helpful in that liquid may be quickly and efficiently drained from the reaction vessel without using the pipettor. This enables test protocols to be run more quickly and reduces the possibility of the pipettor being contaminated by waste. Furthermore, a pipettor aspirating liquid out of the input will often leave a residual amount of liquid behind, while an output port makes it easy to fully-drain the reaction vessel. Thus, good exchange of fluids during wash steps is facilitated by the presence of a dedicated drain.

In some embodiments, the reaction vessel is a fluid container. In some embodiments, the fluid container is configured to hold a sample and/or one or more reagents. In some embodiments, the reaction vessel is a cuvette. In some embodiments, the reaction vessel is a container. In some embodiments, the reaction vessel is an Eppendorf tube. In some embodiments, the reaction vessel is a sample tube. Additional details regarding exemplary reaction vessels that may be used in this design and the hardware needed to enable them to drain are described in PCT Application No.: PCT/US2024/028033, which is hereby incorporated by reference in its entirety. In some embodiments the reaction vessels are part of a single monolithic strip that may be placed into the analytical module as a single consumable.

In some embodiments, the reaction vessel comprises one or more sample vials. The sample vial(s) hold the sample(s) that are to be used in the assay(s). In some embodiments, after a sample is used, the sample vial is replaced.

In some embodiments, similar to the rotating shuttle, the linear shuttle embodiment may also have reaction vessels with drains. FIG. 11 shows an embodiment of a linear fluidic sub-assembly. Like the valved fluidic assembly shown in FIGS. 9A-9B and FIG. 10, this embodiment has a heat block in which the reaction vessels reside. The heat block is mounted to a fluidic manifold and a radial O-ring seal provides a fluid-tight-connection between each reaction vessel and a corresponding valve.

This fluidic sub-assembly may take the place of the translating shuttle of FIG. 8A-8S, wherein it is mounted to a linear stage and moved from one location to another, enabling the reaction vessels to be addressed by the pipettor, a detector (such as a photomultiplier tube, silicon photodiode or silicon photomultiplier), or magnets in turn.

Another aspect of the present disclosure is that instead of using a single motor to accurately-position and aggressively-shake the shuttle or fluidic sub-assembly, two separate motors may take on these functions independently. A shaker sub-assembly may comprise a motor separate and distinct from that of a positioning motor. FIG. 12 shows the fluidic sub-assembly of FIG. 11 mounted to a small linear stage. Many different mechanisms may be used to shake the fluidic sub-assembly back-and-forth on the small stage; the one shown in FIG. 12 is a scotch yoke mechanism, wherein a motor having an eccentric post (the scotch yoke “pin”) is positioned within a slot (the scotch-yoke “follower”) which is connected to the fluidic sub-assembly. As the shaft of the shake-motor spins, the eccentric pin moves freely up and down in the slot, pulling and pushing the fluidic sub-assembly forward and backward and thereby shaking the contents of the reaction vessels. As will be appreciated by those knowledgeable in the art, many other mechanical mechanisms may also be used to accomplish this rapid back-and-forth motion.

In some embodiments, the shaker sub-assembly of FIG. 12 may in turn be mounted to a second, linear stage, so that it may be moved accurately from one position to another to be addressed by different parts of the system. In FIG. 13 the sub-assembly may be moved accurately between magnets, a pipettor, and a detector. This embodiment of the analytical module may be an immunoassay module.

The embodiment shown in FIG. 13 uses two motors and two linear stages to enable the necessary shake and translation functions. There may be considerations such as the cost and lifetime of the motor(s), and the overall form factor of the device that make it advantageous to separate functions.

While this separation of functions has been illustrated with a valved linear design, it will be appreciated that it might also be used with any of the disclosed embodiments. An un-valved rotary design (FIG. 1A-1B) could also use two separate motors to accomplish the shaking and positioning.

### System-Level Hardware Supporting the Analytical Module

Another aspect of the present disclosure includes a system for performing measurements of a fluid using the analytical module, the system comprising the analytical module of the present disclosure, and system-level resources such as a housing, motion system, pipettor, syringe pumps, system fluid tank, degasser, waste pump, waste tank, control electronics, and software.

FIG. 17 shows a multi-modal analytical system that includes the analytical module of the present disclosure, 1758, auxiliary IAM waste pump bank 1756, and IAM wash pump 1714.

IAM wash pump 1714 may be connected to the IAM wash manifold, which is best shown in FIG. 8D. With reference to FIG. 8D, the IAM wash pump may be connected to input hole 857, and may drive fluid through a wash channel in the manifold to multiple parallel dispense probes. The pump may deliver fluid fast enough that a substantially equal pressure drop occurs across each of the dispense probes, causing substantially the same amount of fluid to be dispensed through each of the parallel wash probes during dispense operations. In some embodiments the IAM wash pump is a membrane pump, diaphragm pump, or peristaltic pump.

IAM waste pump bank 1756 may also be connected to the IAM wash manifold. With reference to FIG. 8G-8J, each individual channel of the IAM waste pump bank may connect to an individual aspirate probe. For example, with reference to FIG. 8G-8J, aspirate probe 849 may be fluidically connected to an individual waste output hole 865, which may be individually connected to one of the IAM waste pumps in IAM waste pump bank 1756.

In some embodiments the IAM waste pump bank 1756 contains one pump for every reaction vessel in the analytical module. By providing an individual waste pump for each individual reaction vessel, the aspirate operations in the vessels are displacement-driven and are decoupled from each other. However, in some alternative embodiments, the IAM waste pump bank may be replaced with a single waste pump that pulls on multiple aspirate probes in parallel, and thus uses pressure-driven flow. In some embodiments the pump(s) in IAM waste pump bank 1756 are membrane pumps, diaphragm pumps, or peristaltic pumps.

### Waste Pump

As shown in FIG. 17, in some embodiments, the system may further include a waste pump 1752 that may be used to remove fluid from the system.

In some embodiments, the waste pump is a peristaltic pump, a membrane pump, or a diaphragm pump. In some embodiments, the pump comprises an evacuated gas cylinder, configured to create a pressure difference across the fluid in the fluid container by pulling on their outlets.

In some embodiments, the pump is a pneumatic pump. In some embodiments, the pump comprises a pressurized gas cylinder to create a pressure difference across the fluid in the container by applying pressure to their inlets.

In some embodiments the waste pump is connected to the outlet of one or more components in the system. For instance, the waste pump may be connected to the output of waste-wash stations 1731 and 1732.

### Waste Tank

In some embodiments, such as that shown in FIG. 17, the system of the present disclosure comprises a waste tank. In some embodiments, where a waste tank is present, the system comprises a channel or tube connecting the output of the IAM waste pump bank and the output of waste pump to the waste tank. The waste tank can include a common single waste collection reservoir (storage volume) as shown in FIGS. 16-17.

### Cleaning Fluid Tank

As shown in FIG. 17, in some embodiments, the system further comprises a cleaning fluid tank. The cleaning fluid tank may be fluidically connected directly to one or more pipettors so that a pipettor can dispense cleaning fluid into the RVs in the analytical module to clean them. Alternatively, as illustrated in FIG. 16, the cleaning fluid may be connected to waste/wash stations, and the pipettor may first aspirate cleaning fluid from the waste/wash stations and then dispense it into the RVs of the analytical module to clean them.

### Cleaning Pump

As shown in FIG. 17, in some embodiments, the system further comprises a cleaning pump. The cleaning pump may be used to pump cleaning fluid from the cleaning fluid tank, to the immunoassay module and/or to waste/wash stations, where it may be used to clean the pipettors).

### Degasser

In some embodiments, the system further comprises a degasser. The degasser can be used to degas fluids before they are used in the system.

### Pipettes

As shown in FIG. 17, in some embodiments, the system further comprises one or more pipettor(s) for pipetting and/or mixing the sample and/or reagents from consumable cartridges to the reaction vessels in the analytical module. In some embodiments, the pipettor(s) are automated pipettor(s). In some embodiments, the system comprises a plurality of pipettors. In some embodiments, the pipettor(s) are mounted to arms on a robot, such as an XYZ gantry robot to enable them to move to different places in the system. An example of the pipettor configuration and orientation is provided in FIG. 15A-15B.

### Waste and Wash Stations

As shown in FIG. 17, in some embodiments, the system further comprises one or more waste/wash stations. The waste/wash station(s) can be used to accept waste from the pipettor(s) and to wash the inside and outside of the pipettors.

An exemplary waste/wash station that may be used with the system is shown in FIG. 16. It includes a shallow blind hole that can be used to clean a relatively short portion of the end of the pipette. It also includes a deep blind hole that can be used to clean a longer portion of the pipette. The waste/wash station also includes a pipette cleaning fluid input that communicates through a fluidic channel to a pipette cleaning fluid hole. The waste/wash station further includes a small waste reservoir, which is filled by spill-over from liquids exiting the cleaning fluid hole, shallow cleaning hole.

During a typical cleaning operation, the pipette may first optionally eject its contents into the small waste reservoir and then move to the blind shallow cleaning hole and prime system fluid into it. This priming bathes the inside and outside of the pipette with system fluid and is often sufficient to clean both the inside and outside of the pipette.

If a more stringent clean is required, the pipette may position itself in the “extra-cleaning fluid hole”. A cleaning-fluid pump then pumps cleaning fluid into the extra-cleaning fluid hole, where it bathes the outside of the pipettor, and may be pulled into the inside of the pipettor if desired. Next, the pipettor moves to the deep cleaning hole, and there performs a series of system-fluid primes to remove residual cleaning fluid from the pipette.

In some embodiments the waste and wash station may also provide a source of cleaning fluid that may be used to clean or decontaminate parts of the analytical module. For example, the pipettor may transfer cleaning fluid from the waste and wash station to the reaction vessels in the analytical module(s).

### Consumable Reagent Plate

As shown in FIG. 18A-18B, the system further comprises one or more consumable reagent plates and reaction vessels. The reagent plate(s) and reaction vessels may hold the reagents that may be used in the assay(s). When the reagents are used up, the consumable reagent plate(s) and reaction vessel(s) are replaced.

### Mixing Apparatus

In some embodiments, the system further comprises a mixing apparatus. A non-limiting example of a mixing apparatus is a stir-pipettor in which the pipette is mounted on a flange that is eccentrically attached to a motor shaft. When the motor spins, the movement of the end of the flange where the pipette is mounted describes an oval or circular arc. The circular motion of the pipette can be used to efficiently stir liquids in fluid containers. An example of a stir-pipettor is provided in FIG. 15A-15B.

In some embodiments the movement of the pipette tip when the motor is actuated describes a rough circle having a diameter of 1 mm, 2 mm, 3 mm, 4 mm, or 5 mm. In some embodiments, the motor operates at 5, 10, 15, 20, 25, 30, 35, or 40 revolutions per minute, causing the pipette to also move in an arc at these frequencies.

Other stirring embodiments include magnetic stir bars or magnetic balls that may be placed inside fluid containers and actuated with a magnet, such as a bar magnet that may be positioned outside of the fluid container. Movement of the bar magnet affects movement of the balls or bar magnets within the fluid container, thereby creating turbulence that mixes the fluids. Another non-limiting example of a mixing apparatus includes mechanical features such as propellors or impellors that move into the fluid container to mix and retract from the cuvettes during measurement operations. In some embodiments, the system comprises mechanical means of mixing one or more fluids within the fluid container. In some embodiments, the system comprises non-mechanical means of mixing fluids within the fluid container.

### Methods of Performing an Immunoassay on the Analytical Module

An aspect of the present disclosure includes methods for performing one or more immunoassay using analytical module of the present disclosure. The analytical module may be used to facilitate biological assays in a low-cost, rapid, and efficient manner. An exemplary assay is a magnetic-bead-based immunoassay. Non-limiting possible sequences of method steps that can be used to perform such an assay are listed in Table 1 as depicted in FIG. 19. The tables also list the location at which the RVs must be positioned for each step along with information about when an external pipettor is engaged.

In some embodiments, the method comprises one or more steps outlined in FIG. 19. For example, in some embodiments, the method includes operation 1901 through operation 1916.

Operation 1901 may include placing RVs filled with blocking buffer and magnetic beads conjugated to capture antibody(s) against cardiac troponin I into the movable shuttle when the shuttle is in the load position.

Operation 1902 may include dispensing sample and/or a negative control with troponin cardiac I and detector-antibody(s) labelled with horse radish peroxidase into the reaction vessels when the shuttle is in the shake-read-or-add-reagents position, and an external pipettor is engaged.

Operation 1903 may include mixing and incubating the reaction vessel contents for a period of time at a particular temperature. In some embodiments the mixing is performed by shaking the shuttle back and forth vigorously. In some embodiments the mixing is performed for 5-20 minutes at a temperature between 20 and 37 degrees Celsius.

Operation 1904 may include pelleting beads in the reaction vessels when the shuttle is in front of the magnetic-manifold assembly

Operation 1905 may include dispensing wash solution into the reaction vessels while the shuttle position remains at the of magnet manifold. and the wash manifold is in the down (engaged) position.

Operation 1906 may include slowly moving the shuttle back and forth a short distance in the magnet-manifold position, as bead pellets are magnetically held against walls of the reaction vessels to facilitate pellet washing

Operation 1907 may include aspirating wash solution from RVs while the shuttle is in the magnet-manifold position and the wash manifold remains in the down (engaged) position.

Operation 1908 may include repeating operation 1905 through operation 1907. In some embodiments the operations are repeated 5 to 7 times.

Operation 1909 may include moving the shuttle to a location where external pipette engagement is possible, and using the pipette to dispense a chemiluminescent substrate to the RVs for interaction with an enzyme. In some embodiments the enzyme is horse radish peroxidase.

Operation 1910 may include shaking the reaction vessels for a period of time at a given temperature. In some embodiments the shuttle is in a position where it can shake back-and-forth vigorously to enable the beads to be resuspended and mixed with chemiluminescent substrate. In some embodiments the mixing and bead resuspension occurs for between 10 and 30 seconds at 37 degrees Celsius.

Operation 1911 may include reading the chemiluminescent signal in the reaction vessels with the detector while the shuttle is in the read position. In some embodiments the detector may sequentially read the signal from all the reaction vessels in the shuttle.

Operation 1912 may include dispensing probe-cleaning solution into the reaction vessels while the shuttle is in the add-reagents position and an external pipettor is engaging with the reaction vessels.

Operation 1913 may include moving the shuttle back to the magnet-manifold and pelleting the beads in the reaction vessels.

Operation 1914 may include engaging the wash-manifold with the reaction vessels and aspirating fluid out of the reaction vessels to waste.

Operation 1915 may include dispensing wash fluid into the reaction vessels while the wash-manifold remains engaged and the beads remain pelleted.

Operation 1916 may include repeating operation 1914 and operation 1915 a certain number of times. In some embodiments the operations are repeated three times.

A protocol may be performed using the linear translating stage (for example, FIG. 8). An exemplary result of 20 replicates each of negative and positive controls consisting of blocking buffer without cardiac troponin I and blocking buffer with recombinant cardiac troponin I at 50 picograms of troponin I per mL blocking buffer is shown in the box and whisker plot of FIG. 14 demonstrating a limit-of-detection and limit-of-quantitation (CV <10%) of 4 and 50 picograms of troponin I per mL buffer.

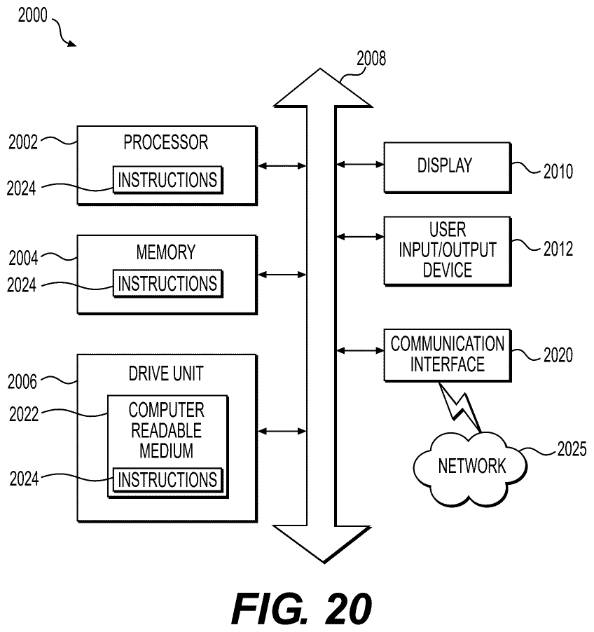

FIG. 20 depicts a controller for the system, according to one or more embodiments. As shown in FIG. 12, controller 2000 may be included in or connected to an analytical immunoassay module described herein including module 100 and module 800. Controller 2000 may include one or more controllers. The controller 2000 may include a set of instructions that can be executed to cause the controller 2000 to perform any one or more of the methods or computer-based functions disclosed herein. The controller 2000 may operate as a standalone device or may be connected, e.g., using a network, to other computer systems or peripheral devices.

In a networked deployment, the controller 2000 may operate in the capacity of a server or as a client in a server-client user network environment, or as a peer computer system in a peer-to-peer (or distributed) network environment. The controller 2000 can also be implemented as or incorporated into various devices, such as a power converter, a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 2000 can be implemented using electronic devices that provide voice, video, or data communication. Further, while the controller 2000 is illustrated as a single system, the term “system” shall also be taken to include any collection of systems or sub-systems that individually or jointly execute a set, or multiple sets, of instructions to perform one or more computer functions.

As depicted in FIG. 20, the controller 2000 may include a processor 2002, e.g., a central processing unit (CPU), a graphics processing unit (GPU), or both. The processor 2002 may be a component in a variety of systems. The processor 2002 may be one or more general processors, digital signal processors, application specific integrated circuits, field programmable gate arrays, servers, networks, digital circuits, analog circuits, combinations thereof, or other now known or later developed devices for analyzing and processing data. The processor 2002 may implement a software program, such as code generated manually (i.e., programmed).

The controller 2000 may include a memory 2004 that can communicate via a bus 2008. The memory 2004 may be a main memory, a static memory, or a dynamic memory. The memory 2004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 2004 includes a cache or random-access memory for the processor 2002. In alternative implementations, the memory 2004 is separate from the processor 2002, such as a cache memory of a processor, the system memory, or other memory. The memory 2004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 2004 is operable to store instructions executable by the processor 2002.

The functions, acts or tasks illustrated in the figures or described herein may be performed by the processor 2002 executing the instructions stored in the memory 2004. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As depicted, the controller 2000 may further include a display 2010, such as a liquid crystal display (LCD), an organic light emitting diode (OLED), a flat panel display, a solid-state display, a cathode ray tube (CRT), a projector, a printer or other now known or later developed display device for outputting determined information. The display 2010 may act as an interface for the user to see the functioning of the processor 2002, or specifically as an interface with the software stored in the memory 2004 or in the drive unit 2006.

Additionally or alternatively, the controller 2000 may include an input device 2012 configured to allow a user to interact with any of the components of controller 2000. The input device 2012 may be a number pad, a keyboard, or a cursor control device, such as a mouse, or a joystick, touch screen display, remote control, or any other device operative to interact with the controller 2000.

The controller 2000 may also or alternatively include drive unit 2006 implemented as a disk or optical drive. The drive unit 2006 may include a computer-readable medium 2022 in which one or more sets of instructions 2024, e.g. software, can be embedded. Further, the instructions 2024 may embody one or more of the methods or logic as described herein. The instructions 2024 may reside completely or partially within the memory 2004 and/or within the processor 2002 during execution by the controller 2000. The memory 2004 and the processor 2002 also may include computer-readable media as discussed above.

In some systems, a computer-readable medium 2022 includes instructions 2024 or receives and executes instructions 2024 responsive to a propagated signal so that a device connected to a network 2070 can communicate voice, video, audio, images, or any other data over the network 2070. Further, the instructions 2024 may be transmitted or received over the network 2070 via a communication port or interface 2020, and/or using a bus 2008. The communication port or interface 2020 may be a part of the processor 2002 or may be a separate component. The communication port or interface 2020 may be created in software or may be a physical connection in hardware. The communication port or interface 2020 may be configured to connect with a network 2070, external media, the display 2010, or any other components in controller 2000, or combinations thereof. The connection with the network 2070 may be a physical connection, such as a wired Ethernet connection or may be established wirelessly as discussed below. Likewise, the additional connections with other components of the controller 2000 may be physical connections or may be established wirelessly. The network 2070 may alternatively be directly connected to a bus 2008.

While the computer-readable medium 2022 is depicted to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 2022 may be non-transitory, and may be tangible.

The computer-readable medium 2022 can include a solid-state memory such as a memory card or other package that houses one or more non-volatile read-only memories. The computer-readable medium 2022 can be a random-access memory or other volatile re-writable memory. Additionally or alternatively, the computer-readable medium 2022 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 2000 may be connected to a network 2070. The network 2070 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 2070 may include wide area networks (WAN), such as the Internet, local area networks (LAN), campus area networks, metropolitan area networks, a direct connection such as through a Universal Serial Bus (USB) port, or any other networks that may allow for data communication. The network 2070 may be configured to couple one computing device to another computing device to enable communication of data between the devices. The network 2070 may generally be enabled to employ any form of machine-readable media for communicating information from one device to another. The network 2070 may include communication methods by which information may travel between computing devices. The network 2070 may be divided into sub-networks. The sub-networks may allow access to all of the other components connected thereto or the sub-networks may restrict access between the components. The network 2070 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component or object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the operations of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

While the invention has been particularly shown and described with reference to a preferred embodiment and various alternate embodiments, it will be understood by persons skilled in the relevant art that various changes in form and details can be made therein without departing from the spirit and scope of the invention.

All references, issued patents and patent applications cited within the body of the instant specification are hereby incorporated by reference in their entirety, for all purposes.

What is claimed is:

1. An analytical module comprising:
a rigid base;
a motor rigidly attached to the rigid base;
a cylindrical housing rigidly attached to the rigid base and having a hole in a bottom through which a shaft of the motor protrudes, the housing including one or more magnets and a sensor;
a shuttle attached to a rotating shaft of the motor, the shuttle being nested within the housing and free to rotate within the housing, the shuttle configured to hold one or more reaction vessels, and comprising a flag configured to interact with the sensor on the housing to define a unique position;
a detector connected to the housing; and
a shroud positioned so as to shield the detector from ambient light.

2. The analytical module of claim 1 wherein the motor may be driven back-and-forth to cause the shuttle containing the one or more reaction vessels to rotate back-and-forth and thereby cause a liquid within the reaction vessels to mix, and to cause particles within the reaction vessels to be resuspended.

3. The analytical module of claim 2 wherein the motor is driven back-and-forth at a frequency of between 1 and 20 cycles per second.

4. The analytical module of claim 2 wherein the motor that causes the shuttle to oscillate back and forth for mixing may also be used to position the shuttle at precise locations in the housing.

5. The analytical module of claim 1 wherein the analytical module further includes a double pipettor probe configured to interact with the one or more reaction vessels, the double pipettor probe including a first probe and a second probe.

6. The analytical module of claim 1 wherein the analytical module further includes a wash manifold configured to translate up and down between two positions, the wash manifold having pairs of aspirate and dispense probes, each pair of probes being configured so that when the wash manifold is in one of its position, the probes are engaged with corresponding reaction vessels.

7. The analytical module of claim 6 wherein the shuttle can be rotated between multiple unique positions in the housing, the positions including;
(a) a reaction vessel load and reaction vessel unload position where one or more reaction vessels may be loaded and unloaded;
(b) a magnet-engagement position where the one or more reaction vessels abut magnets in the housing;
(c) a wash position in which the one or more reaction vessels are positioned under the wash manifold and may engage with the wash manifold when it is one of its positions;
(d) a shake position in which the one or more reaction vessels are positioned far enough away from the magnets that a force from the magnets has no appreciable effect on contents of the one or more reaction vessels, and the one or more reaction vessels may be aggressively shaken back-and-forth to mix their contents and/or resuspend one or more particles within them; and
(e) a read position in which the one or more reaction vessels may be sequentially positioned next to the detector so that light from within or shining through the one or more reaction vessels may be collected by the detector.

8. The analytical module of claim 1, wherein the rotating shuttle is also a heatblock and has an attached heating element.

9. The analytical module of claim 1, wherein each reaction vessel has a drain, and the rotating shuttle further includes a valve configured to gate the drain of each reaction vessel.

10. The analytical module of claim 9, wherein the module further includes a manifold including one or more fluidic paths fluidically connected to the one or more reaction vessels through the valves.

11. An immunoassay module including:
a system to perform magnetic bead based immunoassays wherein the system is configured to shake one or more reaction vessels back and forth to accomplish mixing and bead resuspension.

12. The immunoassay module of claim 11, wherein the module includes:
a rigid base;
a motor connected to the rigid base;
a linear translation stage configured to translate along the base;
a shuttle connected to the linear translation stage so that the shuttle moves linearly with the linear translation stage;
one or more reaction vessels connected to the translating shuttle;
a detector connected to the base, the detector being at least partially covered by an opaque shroud;
a magnet-manifold connected to the base, a magnet manifold including one or more magnets; and
a sensor connected to the shuttle that works in concert with another piece of hardware mounted to the base, such as a magnet, flag, or piece of metal, to define a particular position along the base.

13. The immunoassay module of claim 12 wherein the system further includes a wash manifold configured to translate up and down between two positions, the wash manifold having pairs of aspirate and dispense probes, each pair of probes being configured so that when the wash manifold is in one of its position, the probes are engaged with corresponding reaction vessels.

14. The immunoassay module of claim 11, wherein the module includes:
a fluidic sub-assembly having reaction vessels with output drains and valves that gate the outputs of the reaction vessels; and
a shaker sub-assembly to which the fluidic sub-assembly may be mounted, the shaker sub-assembly having a shake motor separate and distinct from that of a positioning motor, the shake motor being configured to shake the fluidic sub-assembly back and forth at a frequency between 1 and 50 cycles per second.

15. The immunoassay module of claim 14, wherein the fluidic sub-assembly includes:
a heatblock including one or more holes or slots for reaction vessels;
one or more reaction vessels having output drains inserted into the slots or holes in the heatblock;
a manifold connected to the heatblock, the manifold including one or more O-rings and a waste channel, the O-rings configured to form liquid-tight seals with the outputs of the reaction vessels, and to thereby create passages between the output of the reaction vessels and the manifold;
one or more valves connected to the manifold, the valves gating the outputs of the reaction vessels such that when the valves are closed, the reaction vessels cannot drain, but when the valves are open, the outputs of the reaction vessels are connected through the valves to the waste channel; and
a pump attached to the waste channel and configured so that when a valve is open, the pump can pull contents of an associated reaction vessel out of the vessel to waste.

16. The immunoassay module of claim 14, wherein the shaker sub-assembly includes:
a shaker sub-assembly base;
a linear stage shake carriage to connect to an immunoassay fluidic sub-assembly, the linear stage shake carriage connected to the shaker sub-assembly base;
a linear stage shake rail connected to the linear stage shake carriage;
a scotch yoke connected to the shaker sub-assembly base, the scotch yoke including a scotch yoke pin and scotch yoke follower; and
a shake motor connected to the scotch yoke.

17. The immunoassay module of claim 14, the system further including a linear positioning module connected to the shaker sub-assembly.

18. The immunoassay module of claim 17, wherein the linear positioning module includes:
a frame;
one or more magnets connected to the frame;
a wash manifold connected to the frame;
a detector connected to the frame; and
a linear positioning stage connected to the frame.

19. The immunoassay module of claim 11, wherein the immunoassay module is embedded within a system that further includes:
(a) a pipettor mounted to a gantry robot;
(b) a reservoir of system fluid;
(c) a pump configured to prime system fluid from the reservoir to the pipettor, and aspirate and dispense fluids into the pipettor;
(d) a reservoir of cleaning fluid;
(e) a waste and wash station for washing the pipettor;
(f) a waste pump for pulling fluid out of the waste and wash station;
(g) a light cover.

20. A method of performing one or more immunoassays with a combination of near-simultaneous actions performed by an instrument assembly based on one or more immunoassay protocols using the analytical module of claim 1.

21. The method of claim 20, wherein the combination of actions includes:
moving a shuttle to a first position where one or more reaction vessels, or a monolithic strip of reaction vessels can be loaded into the shuttle, the reaction vessels containing magnetic beads conjugated to capture antibodies configured to capture an analyte of interest from a sample;
dispensing a plasma, blood, or urine sample and detector antibodies labeled with an enzyme into one or more of the reaction vessels;
moving the shuttle to a second position at which mixing of the sample with the beads can occur through vigorous shaking of the shuttle;
moving the shuttle to a third position at which magnets cause pelleting of the beads in the reaction vessels;
engaging a wash manifold to dispense wash fluid into each of the reaction vessels;
moving the shuttle slowly back-and-forth by a short distance so as to cause the pelleted beads to roll slightly to improve washing efficiency;
aspirating wash fluid out of the reaction vessels through the wash manifold;
repeating the dispense and aspirate steps until the beads are substantially-free of any non-specific binding;
moving the shuttle to a fourth position where it can engage with a system-pipettor, and using the system-pipettor to add chemiluminescent substrate to the reaction vessels, the chemiluminescent substrate configured to react with the enzyme linked to the detector antibody;
moving the shuttle to a fifth position where it can engage with a detector such that luminescence or fluorescence from within the reaction vessels can be read sequentially by the detector; and
using one or more voltages from the detector and a calibration curve stored in a processor, to determine a quantity of analyte in the sample.

22. The method of claim 21 further including additional steps to remove waste and clean a probe after conducting an assay, the additional steps including:
moving the shuttle to the second position where an external pipettor can add a cleaning solution to the reaction vessels;
moving the shuttle to the third (magnet manifold) position so that the magnetic beads in the reaction vessels are pelleted; and
engaging the wash manifold with the reaction vessels and sequentially dispensing and aspirating wash fluid out of the reaction vessels until the probe is clean and the wash vessels are substantially empty.

23. The analytical module of claim 1 wherein each reaction vessel may be used to perform a unique immunoassay.

24. The analytical module of claim 1 wherein one or more consumables used by the module to perform an immunoassays include one reaction vessel and two or three reagent vessels.

25. The analytical module of claim 1 wherein quantity “N” immunoassays may be performed in parallel using quantity “N” reaction vessels and quantity “2N+1” reagent vessels.

26. The analytical module of claim 1 wherein the module leverages cleaning solution provided by a system-level cleaning tank, and wash solution provided by a system-level wash tank.
